(19) United States
(12) Patent Application Publication
(10) Pub. No.: US 2018/0296980 A1
(43) Pub. Date: Oct. 18, 2018

(54) Separation of Biomolecules and/or Demineralization of Solutions Containing Biomolecules and Ions by Electrochemical Ion Exchange

(71) Applicant: Trish Choudhary, Foster City, CA (US)

(72) Inventor: Trish Choudhary, Foster City, CA (US)

(21) Appl. No.: 16/012,697

(22) Filed: Jun. 19, 2018

Related U.S. Application Data
(63) Continuation of application No. 14/913,301, filed on Feb. 19, 2016, now abandoned.
(60) Provisional application No. 61/867,859, filed on Aug. 20, 2013.
(60) Provisional application No. 62/004,049, filed on May 28, 2014.

(51) Int. Cl. B01D 61/44; B01D 61/48; B01D 61/52; B01D 61/58

(52) U.S. Cl. CPC B01D 61/44; B01D 2321/223; B01D 61/48; B01D 61/147; B01D 61/58; B01D 61/52

(57) ABSTRACT

Methods and systems are provided for separation and/or purification of biomolecule(s) from a solution and for demineralization of a solution containing biomolecule(s) and ion(s). The methods and systems described herein include one or more ion exchange membrane(s), (e.g., ion exchange membrane(s) capable of water splitting), in an electrochemical cell, from which bound biomolecule(s) or ion(s) may be recovered from the membrane and separated from other components present in the solution by reversing the polarity of the electrodes. Using methods and systems described herein, biomolecules (e.g., whey proteins and lactose), and ions (e.g., milk salts), are able to be separated and recovered in their native forms with high biological value as premium food grade products. Methods and systems described herein offer a significant advantage over traditional processes used (e.g., in the food and beverage industry), for cost effective and chemical-free processing/extraction of valuable products from complex solutions such as whey.

### CROSS-REFERENCE TO RELATED APPLICATIONS

This application claims the benefit of U.S. Provisional Application No. 61/867,859, filed on Aug. 20, 2013, and U.S. Provisional Application No. 62/004,049, filed on May 28, 2014, both of which are incorporated by reference herein in their entireties.

### FIELD OF THE INVENTION

The invention relates to methods for separation and/or purification of biomolecules and methods for demineralization of a biomolecule-containing solution, in particular by electrochemical ion exchange in an electrochemical cell that contains at least one ion exchange membrane, such as a membrane that is capable of water splitting.

### BACKGROUND

Ion exchange chromatography has been used for decades for the separation and purification of biomolecules, such as proteins from an aqueous solution. Ion exchange is also widely used in many industries to remove ions or demineralize solutions. Ion exchange is a reversible chemical reaction where charged molecules or ions (atoms or molecules that have lost or gained an electron and therefore acquired an electrical charge), present in an aqueous solution, are exchanged for charged ions attached to a stationary solid material. The stationary material may be in the form of resin beads (e.g., polystyrene) or extruded membranes, both carrying exchangeable (e.g., covalently bonded) charged functional groups, which interact with ions in solution. Ion exchangers are differentiated by the form of resins packed into bed columns, e.g., either positively or negatively charged resins. A cation exchanger contains resins displaying negatively charged functional groups to bind and retain positively charged cations from solution. Conversely, an anion exchanger contains resins displaying positively charged functional groups to bind and retain negatively charged anions.

Both anion and cation resins may be produced from the same basic organic polymers, but differ in the attached ionizable functional group(s), which determines the chemical behavior of the resin. Resins can be broadly classified as either strong or weak acid cation exchangers or strong or weak base anion exchangers depending on their range of ionization over the pH spectrum (e.g., pH 1.0-14.0). Strong acid and strong base resins are highly ionized, hence their exchange capacity is independent of solution pH (resins are ionized over the entire pH range (pH 1.0-14.0)). For weak acid and weak base resins, the ionizable group has limited exchange capacity above or below a certain pH (below pH 6.0 for weak acids and above pH 7.0 for weak bases), hence, weak acid and weak base resins are strongly influenced by the solution pH.

In order to separate a biomolecule of interest (e.g., protein), using ion exchange, an aqueous solution, or mobile phase, containing one or more biomolecule(s) of interest is applied to the ion exchange resin (e.g, cationic or anionic exchange column). Biomolecules that carry a charge opposite to the stationary phase bind to the resin and biomolecules with the same charge or no charge do not bind and wash out (pass through) with the mobile phase. Biological amphoteric molecules such as proteins contain both acidic and basic functional groups (e.g., amino acids with side chains containing acidic or basic functional groups). Amino acids that make up proteins may be positive, negative, neutral, or polar in nature, which taken together, contribute to a protein's overall charge. If the isoelectric point of a protein is known, the overall charge (either positive or negative), can be precisely controlled by the pH of the mobile phase. The isoelectric point (pI) is the pH at which a particular biomolecule such as a protein, carries no net electrical charge and often precipitates out of solution. Hence, the pI value can affect the solubility of a biomolecule at a given pH. At a pH below its pI, a protein carries a net positive charge; and above its pI it carries a net negative charge.

Various methods may be used to elute bound biomolecule(s) (e.g., protein(s)), from an ion exchange column. One option is to modify the pH of the solution used for elution. For example, when the isoelectric point (pI) of a biomolecule such as a protein, is the same as the pH of a solution, the net charge of the protein will be zero. Therefore, when the pH of the solution used for elution reaches equals the pI of the protein, the protein will no longer bind to the stationary phase and will be released and eluted from the exchange column. A significant drawback of using this method is that once eluted, the protein may denature and precipitate out of the elution buffer. Another option to elute bound biomolecule(s) (e.g., protein (s)), is to increase the salt concentration of the elution buffer solution. As the salt concentration of the elution buffer increases, salt ions (which have a higher competitive ionic binding or attraction to the charged resins), replace the bound biomolecule(s). In the example of proteins, those with weaker ionic interactions with the resin will elute in buffers containing lower salt concentrations, whereas proteins with stronger ionic interactions will remain bound longer. Hence, by using a salt gradient, different proteins can be isolated in separate fractions according to their respective competitive binding interactions or affinities with the resin.

Ion exchange is also widely used in industrial processes to remove unwanted ions from aqueous solutions (demineralization). Examples of such industrial processes are found in the food & beverage, hydrometallurgical, chemical & petrochemical, pharmaceutical, sugar & sweeteners, industrial water softening, and a host of other industries. In this type of application, an aqueous solution, or mobile phase, containing many ions (positive and/or negative), is first applied to the ion exchanger resin (either a cation or anion exchanger). Ions that carry a charge opposite to the stationary phase bind to the resin and ions with the same charge or no charge do not bind and pass through with the mobile phase. The resulting mobile phase (partially demineralized), is then applied to a second ion exchange column with the opposite binding chemistry in order to remove the ions of the opposite charge that passed through the first column. Therefore, by passing the mobile phase sequentially through a cation and anion exchanger, complete ion removal or demineralization may be achieved. Once the ions are bound during either cation or anion exchange, the demineralized aqueous solution or mobile phase, passes through and is collected. The bound ions are then stripped from the resin columns and discarded before the resins are regenerated using acid or base for a subsequent cycle. Unlike biomolecules (e.g., proteins), the binding of ions present in the mobile phase to a cation or anion exchanger may occur irrespective of the pH of the mobile phase.

A major disadvantage of traditional ion exchange is that either positively- or negatively-charged biomolecule(s) (e.g., protein(s)) can be separated (e.g., purified) from an aqueous solution using either a cation or anion exchanger respectively, but rarely both simultaneously. The same disadvantage holds true for removal of both positively- or negatively-charged ions from an aqueous solution simultaneously during demineralization. For example, in order to recover all positively- and negatively-charged biomolecules (e.g., proteins) or ions present in an aqueous solution using ion exchange, both cation and anion exchanger columns must be used sequentially for the same sample, coupled with pH adjustments of the solution in between. In the case of ion removal, mixed resin columns (e.g. containing both cation and anion resins), can be deployed but have typically proven useful only as a final step during water demineralization since regeneration of the mixed beads is not possible. (Each resin type requires either acid or base to regenerate, which cannot be mixed during a “simultaneous” regeneration step). Another disadvantage of traditional ion exchange is that chemicals such as hydrochloric acid (HCl) and sodium hydroxide (NaOH) are used to charge and regenerate the resins as well as, in some cases, elute the bound biomolecules (e.g., proteins) into a buffered solution at a desired pH, and strip the resins of bound ions during a demineralization process. Chemicals such as HCl and NaOH are necessary to drive the acid-base chemistry required for ion exchange to occur. However, they can often cause a significant decrease in the biological activity of the biomolecules being isolated (e.g., in the case of proteins, causing various degrees of protein denaturation). In the example of demineralization of an aqueous solution, once the regeneration process takes place, the bound ions are stripped using acid or base and can no longer be utilized or further processed as functional minerals or salts, and hence, the value of these products cannot be captured.

The nature of traditional ion exchange using resin beads has several other limitations. For example, during separation of a biomolecule (e.g., protein), from a solution (e.g., a biological solution such as whey), other dissolved solids (such as fats and sugars), may have to be removed prior to protein binding to prevent column clogging and/or fouling; processing of solutions containing one or more biomolecule(s) often causes frequent bacterial contamination of the beads requiring additional column stripping and repacking. It would be advantageous to use a system (e.g., an ion exchange system) that separates all charged biomolecules from a solution in a single step, (e.g., both positively- and negatively-charged proteins in their native, non-denatured configurations),regardless of presence of other dissolved solids without the need for chemical regeneration. It would also be advantageous to use a system (e.g., an ion exchange system) that removes all ions (e.g., both positively- and negatively-charged; regardless of valence) from a solution that contains one or more biomolecule(s) and one or more ion(s), (without affecting the conformation of biomolecule(s) and regardless of presence of other dissolved solids present in the solution) in a single step, without the need for chemical regeneration. A system as such would allow for downstream purification of the resulting ions into industrially viable products such as food-grade salts and minerals, and downstream separation and or purification of the remaining demineralized biomolecules remaining in solution.

An example of a solution that contains one or more biomolecule(s) and one or more ion(s) is whey. Whey is a significant byproduct produced during the early stages of cheese making. It is the liquid that remains during the process known as syneresis when rennet or an edible acidic substance is added to milk to produce curds (coagulated protein or casein). In its raw form, whey contains proteins, fat, cholesterol, vitamins, minerals (e.g., Cl₂ K, PO₄ and Ca), and a significant amount of lactose (milk sugar). Both cationic and anionic proteins are present in whey. For example, at the natural pH of sweet whey (pH 6.0-6.6), immunoglobulins, lactoferrin, and lactoperoxidase are present as cationic proteins, and β-lactoglobulin, α-lactalbumin, bovine serum albumin, and glycomacropeptides are present as anionic proteins. Traditional resin-based ion exchange methods to extract all of the whey proteins (regardless of charge or size), requires a sequential process of adjusting the pH of whey, to first be passed through a cation exchanger, followed by additional pH adjustments prior to passing the whey through a secondary anion exchanger. It would be advantageous to separate all positively- and negatively-charged proteins from whey simultaneously in a single step process, in their native, biologically-active configurations and in their natural ratios (as is found in milk).

Examples of problems associated with traditional resin-based ion exchange methods for extraction of whey proteins include the high sodium content in the final protein product (carryover from the buffer solution used to adjust the initial pH), a denatured protein level of up to 10% of the total protein (caused by the chemical reaction of the buffer with the resin surface where the protein is bound) and the loss of glycomacropeptides and other immune boosters (present in low concentrations), which fail to bind to the resins. Traditional ion exchange methods also skew the ratio of the proteins towards the most abundant proteins (β-lactoglobulin and α-lactalbumin), due to their strong ionic binding or electrostatic attraction with the charged resin beads compared to that of the remaining, less abundant proteins. This competitive ionic binding leads to loss of several whey proteins that are present in low concentrations and hence, greatly alters the natural ratio of proteins that are found in whey and which will contribute to the final protein product.

A single-step process would allow purification of all whey proteins in their natural ratios and concentrations (as found in milk) regardless of charge, size or strength of ionic binding. Simultaneous recovery of all whey proteins would also significantly reduce the current manufacturing costs and product losses associated with running industrial cation and anion exchangers in tandem. For example, since immunoglobulins, lactoferrin, and lactoperoxidase represent <12% of the total whey proteins, many manufacturers do not run an anion exchange column in addition to the cation exchange column to extract and capture these proteins at large scale due to the increased associated cost. Ironically, immunoglobulins, lactoferrin, and lactoperoxidase have the highest biological value of all whey proteins if extracted in their native forms. A single process that can separate all whey proteins from whey is also advantageous for further downstream processing of the remaining biomolecules present in the deproteinized whey (or ultrafiltration permeate, which is the byproduct of a membrane-based protein extraction system knows as ultrafiltration). Ultrafiltration permeate or deproteinized whey largely contains lactose (milk sugar) and other micronutrients, such as vitamins, salts and minerals, which all have significant uses in the food and pharmaceutical industries if they are extracted at high purity levels. A process that does not require addition of chemicals such as acids or bases to charge and regenerate ion exchange resins would be of great advantage, especially for the production of food-grade products such as whey proteins, lactose sugar, and food-grade salts and minerals at high purity.

Lactose (milk sugar), is a disaccharide carbohydrate formed by the condensation of glucose and galactose to give a β-(1→4) linked product. Lactose can further be classified into α and β forms, both having different solubility properties and thus varying industrial uses. This simple sugar is a significant by-product of whey-protein production using various methods including ultrafiltration and can be referred to as ultrafiltration permeate (UFP), or deproteinized whey. UFP or deproteinized whey cannot be disposed of in the rivers or sprayed on fields as the high sugar content promotes bacterial growth. Lactose degradation by bacteria causes oxygen depletion in water and soil, as it has a high biological oxygen demand (B.O.D.). For perspective, one hundred kilograms of whey has a B.O.D. estimated to be equivalent to the daily activities of 46 people. Thus, it is highly desirable to extract and purify lactose from the other remaining solids in deproteinized whey to, at the very least, reduce its ecological impact during disposal. Lactose has a wide variety of uses in the food and confectionery industries due to its low sweetness (30% that of sucrose), and ability to increase the storage life of products. Human milk contains 7% lactose (compared with 5% in bovine milk), and therefore, lactose is routinely added as an ingredient in the preparation of powdered infant formula. The purest form, α-lactose, is used by the pharmaceutical industry as an excipient, i.e., a compound which is chemically inert, and aids in manufacturing and enhances the biological availability of certain drugs. As such, it is the second most widely used compound and plays an important role as a filler/binder in tablets, capsules and other oral product forms including dry powder inhalers (DPI).

In the example given above of whey as a solution that contains one or more biomolecule(s), it would be advantageous to separate/extract all of the whey proteins regardless of size, charge or concentration from the other components in whey such as fats, milk minerals and lactose, e.g., in a single system. It would also be advantageous to further separate the non-protein components present in deproteinized whey or UFP, into products that can be utilized in the food or pharmaceutical industries (e.g., lactose and milk minerals), for example, using a single system. The major non-protein component of whey is lactose, which requires separation from milk minerals (e.g., demineralization by removal of ions), to varying degrees before it can be utilized as a food ingredient or a pharmaceutical-grade substance.

Lactoferrin is one of the most interesting proteins present in whey, albeit in very low concentrations (approximately 0.1 g/L or 1% of the total whey proteins), hence its high demand and value. It is a glycoprotein capable of binding and transferring Fe³⁺ ions, having antimicrobial, anti-inflammatory and anti-carcinogenic properties. Lactoferrin from human milk seems to affect intestinal iron absorption in infants and hence, there is a large interest in a pure and highly concentrated supply of lactoferrin for uses such as enhancement infant formula. It is very difficult to separate lactoferrin from whey in a cost-effective manner in its biologically active form. It would be advantageous to separate a specific high value protein, such as lactoferrin, in a chemical-free process, by exploiting its high affinity to bind iron (Fe³⁺).

Industrial demineralization of a solution that contains one or more biomolecule(s) and one or more ion(s) such as UFP or whey, currently requires a combination of processes to achieve a high level of ion removal. One of the processes used industrially is nanofiltration, which primarily removes monovalent ions such as Na⁺, K⁺ and Cl⁻ and concentrates the solution for further processing). Multivalent ions (such as Ca²⁺, Mg²⁺, PO4²⁻ and SO4²⁻) are not removed in this process as these ions are too high in molecular weight and cannot pass through the restricted pore size of the nanofilters. Biological solutions such as whey that have been passed through nanofiltration can be referred to as ‘partially’ demineralized and contain higher concentrations of multivalent ions. In order to remove the remaining multivalent salts, the partially demineralized solution can be further processed using various processes such as Reverse Osmosis (RO). Because the osmotic pressure of the RO process stream is quite high, RO membranes must operate at pressures of 400-1,200 psi (29-83 bars), which restricts its use for the high volumes required at an industrial scale. Thus, at industrial scale, additional processes are deployed such as decalcium phosphatization processes, electrodialysis and traditional resin-based ion exchange in order to achieve full, or a high level of demineralization (>90%). Electrodialysis (ED) is used to transport salt ions from one solution to another one through alternating anion and cation exchange membranes while under the influence of an applied electric potential difference. Electrodialysis requires a concentrated feed solution (e.g., pre-treatment using a process such as nanofiltration or reverse osmosis) before it can be effective as a demineralization method. Achieving demineralization rates above 70% using ED results in denaturation of the protein(s) due to the increase in heat (higher demineralization requires longer running times). The ion exchange membranes used in ED are also prone to fouling because of Ca₃(PO₄)₂ and/or protein deposition. In order to achieve full, or a high level of demineralization (>90%) resin-based ion exchange is commonly used as a finishing process. The disadvantages of using resin-based ion exchange have been previously described including use of chemicals for charging and regenerating the resins, the need for sequential cation and anion exchange columns, and product losses associated with protein denaturation.

It would be advantageous to use a single system with the capability to remove all ions (positive and/or negative, monovalent and/or multivalent) from a solution that contains one or more biomolecule(s) and one or more ion(s) such as whey or UFP, in a chemical free process. Simultaneous removal of all ions from a solution that contains one or more biomolecule(s) and one or more ion(s) would significantly reduce the current manufacturing costs and product losses associated with running up to four independent processes in tandem to achieve the same level of full demineralization (e.g., nanofiltration, reverse osmosis, electrodialysis and/or traditional resin-based ion exchange). A process that does not require addition of chemicals such as acids or bases in order to charge and regenerate ion exchange resins would also be of great advantage, especially for the demineralization and production of food-grade products such as whey proteins, milk sugars such as lactose, and milk minerals.

The mineral content of a whey-derived protein product or whey-derived lactose product largely determines its suitability for use as a food or pharmaceutical ingredient. Generally speaking, lower mineral content associated with whey protein and/or lactose powders correlates with higher “grade” product. Much like whey proteins, the minerals present in whey are both cationic and anionic. It would be advantageous to remove all ions (regardless of charge, valance or size) from whey (or a derivative of whey such as UFP), in a single, chemical-free process to produce the highest quality whey protein and lactose products. Minerals in whey serve many purposes in the food and beverage industries. These minerals can be captured as a valuable product stream if extracted with a high level of purity (i.e., without the use of additional chemicals to strip the ions from the resins).

### BRIEF SUMMARY OF THE INVENTION

Methods and systems are provided for separation and/or purification of biomolecule(s) from solutions. Compositions that contain biomolecule(s) separated and/or purified from solutions according to methods described herein are also provided.

Methods and systems are also provided for the demineralization of a solution that contains one or more biomolecule(s) and one or more ion(s). Compositions that contain ions separated and/or purified from a solution that contains one or more biomolecule(s) and one or more ion(s) according to methods described herein are also provided. Demineralized solutions prepared according to methods described herein are also provided. Compositions that contain biomolecule(s) that have been separated from ion(s) according to methods described herein (demineralized biomolecule-containing compositions) are also provided.

In one aspect, a method is provided for separation of one or more biomolecule(s) from a solution. The method includes applying a voltage to an electrochemical cell that includes: (a) a housing that includes an inlet and an outlet; (b) first and second electrodes: (c) at least one water-splitting ion exchange membrane between the first and second electrodes, wherein the water-splitting membrane includes: (i) a cation exchange layer facing the first electrode and including a bound cation; and (ii) an anion exchange layer facing the second electrode and including a bound anion; and (d) a solution that includes the biomolecule(s) (e.g., a biomolecule-containing solution at any pH (e.g., 1.0-14.0)). The solution flows through a continuous channel from the inlet to the outlet of the cell and contacts the first and second electrodes and the cation and anion exchange layers of the water-splitting membrane. The biomolecule(s) present in the solution either bind to the cation exchange layer and/or the anion exchange layer on the water splitting membrane or flow(s) through the electrochemical cell as unbound biomolecule(s).

In various embodiments, biomolecule(s) separated according to the methods provided herein include, but are not limited to, polypeptide(s), polynucleotide(s), carbohydrate(s) such as monosaccharide(s) and/or polysaccharide(s), and/or lipid(s). In some embodiments, the solution that includes the biomolecule(s) comprises, consists of, or consists essentially of a biological solution. In some embodiments, the solution that includes the biomolecule is at least a partially demineralized solution (e.g., a solution in which at least about 10%, 20%, 30%, 40%, 50%, 60%, 70%, 80%, 90%, 95%, or 99% of minerals (e.g., ions) have been removed, for example, but not limited to, using a demineralization method as described herein).

In some embodiments, the biomolecule is produced by a living system, for example, but not limited to, an animal, a plant, a fungus, a bacterium, or a virus. In some embodiments, the biomolecule is a polypeptide, a polynucleotide, a mono-, di-, or oligosaccharide, a lipid, an amino acid, a nucleotide, a vitamin, a primary metabolite, a secondary metabolite, or a natural product. In one embodiment, the biomolecule is lactoferrin, for example, bovine lactoferrin. For example, lactoferrin replaces Fe³⁺ or Fe²⁺ on the water-splitting ion exchange membrane.

In some embodiments, the biomolecule contains a cationic or anionic tag, wherein the tag is charged in the biomolecule-containing solution, and wherein the tag replaces either a bound cation on the cation exchange layer or a bound anion on the anion exchange layer of the water splitting membrane. In one embodiment, the biomolecule is a polypeptide and the tag contains a polyhistidine sequence (e.g., a “his” tag).

In one embodiment, a biomolecule in the biomolecule-containing solution is charged, and the charged biomolecule replaces either a bound cation on the cation exchange layer or a bound anion on the anion exchange layer of the water-splitting membrane. In another embodiment, a biomolecule in the biomolecule-containing solution is uncharged, and the uncharged biomolecule flows through the electrochemical cell as an unbound molecule.

In some embodiments, the biomolecule-containing solution includes a plurality of different biomolecules. In some embodiments, the solution includes a plurality of different biomolecules and a plurality of different ions. In various embodiments, the plurality of different biomolecules includes polypeptides, polynucleotides, monosaccharides, polysaccharides, and/or lipids. In some embodiments, the plurality of different biomolecules includes a plurality of charged biomolecules and a plurality of uncharged biomolecules. In some embodiments, the plurality of charged biomolecules includes at least one cationic biomolecule and at least one anionic biomolecule, wherein the at least one cationic biomolecule replaces a bound cation on the cation exchange layer of the water splitting-membrane and the at least one anionic biomolecule replaces a bound anion on the anion exchange layer of the water-splitting membrane.

In some embodiments, the concentration, form (e.g., secondary, tertiary and/or quaternary structure), and/or biological activity of an uncharged biomolecule, substantially all uncharged biomolecules, or all uncharged biomolecules remains unchanged or substantially unchanged in the solution that exits the electrochemical cell, with respect to the solution that entered the cell.

In one embodiment, the biomolecule-containing solution that includes at least one cationic biomolecule and at least one anionic biomolecule includes cationic and anionic polypeptides, wherein the cationic polypeptides replace bound cations on the cation exchange layer of the water-splitting membrane and the anionic polypeptides replace bound anions on the anion exchange layer of the water-splitting membrane. In some embodiments, the solution that contains cationic and anionic polypeptides includes comprises, consists of, or consists essentially of whey or a derivative thereof, including, but not limited to one or more retentate(s) or one or more permeate(s) of whey filtration, e.g., ultrafiltration, microfiltration, or nanofiltration. In some embodiments, the whey or derivative thereof further includes uncharged fat and lactose, which flow through the electrochemical cell as unbound molecules.

Some embodiments of the methods herein further include reversing the polarity of the first and second electrodes, and introducing a regeneration solution into the electrochemical cell, wherein the bound charged biomolecule(s) is (are) expelled from the membrane, and wherein the charged biomolecule(s) exit(s) through an outlet of the electrochemical cell in a regenerated solution. In some embodiments, the bound charged biomolecule(s) is (are) replaced by H⁺ or OH⁻ produced in the water splitting reaction. In some embodiments, the bound charged biomolecules include bound cationic and anionic polypeptides, which are expelled from the membrane and exit through an outlet of the electrochemical cell. In some embodiments, the bound cationic and anionic polypeptides are replaced by H⁺ or OH⁻ produced in the water splitting reaction. In some embodiments, the cationic and anionic polypeptides are recovered in native (e.g., biologically active) form. In some embodiments, the cationic and anionic polypeptide(s) are recovered at a higher concentration(s) than in the solution that entered the electrochemical cell.

In some embodiments, the concentration, form (e.g., secondary, tertiary and/or quaternary structure), and/or biological activity of at least one charged biomolecule, substantially all charged biomolecules, or all charged biomolecules remains unchanged or substantially unchanged in the regenerated solution, with respect to the solution that entered the cell.

In some embodiments, at least a portion (e.g., at least about 10%, 20%, 30%, 40%, 50%, 60%, 70%, 80%, 90%, 95%, or 99%) or substantially all (e.g., at least about 95%, 96%, 97%, 98%, 99%, 99.5, 99.8%, or 99.9%) of the recovered cationic and/or anionic polypeptides retain at least a portion (e.g., at least about 10%, 20%, 30%, 40%, 50%, 60%, 70%, 80%, 90%, 95%, or 99%) of their biological activity(ies). In some embodiments, at least a portion (e.g., at least about 10%, 20%, 30%, 40%, 50%, 60%, 70%, 80%, 90%, 95%, or 99%) of the recovered cationic and/or anionic polypeptides remain solubilized in the regenerated solution. In some embodiments, at least a portion of the recovered cationic and/or anionic polypeptides precipitate from the regeneration solution (for example, due to pH of the regeneration solution equaling the isoelectric point of the polypeptide(s)).

In some embodiments, the biomolecule-containing solution that enters the electrochemical cell comprises, consists of, or consists essentially of whey or a derivative thereof, wherein cationic and anionic polypeptides of whey bind to the water-splitting membrane. In some embodiments, uncharged lactose and fat flow through the electrochemical cell as unbound molecules. In some embodiments, the lactose and fat do not foul the membrane as they flow through the electrochemical cell. In some embodiments, the method further includes reversing the polarity of the first and second electrodes, wherein the bound cationic and anionic polypeptides exit through an outlet of the electrochemical cell as a regenerated solution that includes cationic and anionic polypeptides of whey. In some embodiments, the bound cationic and anionic polypeptides of whey are replaced by H⁺ or OH⁻ produced in the water splitting reaction. In some embodiments, a protein powder is produced from the recovered cationic and anionic polypeptides of whey, separated from uncharged lactose and fat of whey, as described herein. In some embodiments, the cationic and anionic polypeptides of whey in the regenerated solution are present at a total concentration that is equal to or higher (for example, about 2 fold to about 3 fold higher) than in the whey (or derivative thereof) solution that entered the electrochemical cell. In some embodiments, the fat concentration in the regenerated solution is about 8 fold to about 9 fold lower than in the whey (or derivative thereof) solution that entered the electrochemical cell. In some embodiments, the concentration of lactose in the regenerated solution is about 25% or less than the concentration of lactose present in the whey solution that entered the electrochemical cell.

In one embodiment, the biomolecule-containing solution includes at least one specific polypeptide (cationic or anionic) that replaces bound cations on the cation exchange layer of the water-splitting membrane or replaces bound anions on the anion exchange layer of the water-splitting membrane, due to specific targeted binding. In one embodiment, the specific polypeptide is lactoferrin which binds to the cation exchange layer of the water-splitting membrane due to specific targeted binding with Fe³⁺ ions, e.g., as described in Example 4.

In another aspect, a method is provided for demineralization of a solution that contains one or more biomolecule(s) and one or more ion(s). The method includes applying a voltage to an electrochemical cell that includes: (a) a housing that includes an inlet and an outlet; (b) first and second electrodes: (c) at least one water-splitting ion exchange membrane between the first and second electrodes, wherein the water-splitting membrane includes: (i) a cation exchange layer facing the first electrode and including a bound cation; and (ii) an anion exchange layer facing the second electrode and including a bound anion; and (d) a solution that contains one or more biomolecule(s) and one or more ion(s) (e.g., a biomolecule and ion containing solution at any pH (e.g., 1.0-14.0)). The solution that contains one or more biomolecule(s) and one or more ion(s) flows through a continuous channel from the inlet to the outlet of the cell and contacts the first and second electrodes and the cation and anion exchange layers of the water-splitting membrane. Depending on their charge, ions bind to the cation exchange layer or the anion exchange layer on the water splitting membrane, and the remaining solution flow(s) through the electrochemical cell as a demineralized solution, e.g., a solution in which at least one ion has been removed or its concentration reduced. In some embodiments, the flow rate and/or binding capacity of the water-splitting membrane(s) of the electrochemical cell is configured or adjusted to maximize binding of ions to the membrane and such that at least a portion, substantially all, or all biomolecules (charged and uncharged) will flow through the electrochemical cell while substantially all or all ions remain bound to the membrane(s). In one embodiment, ions bind to the water-splitting ion exchange membrane with a higher competitive ionic binding (attraction) than cationic and anionic polypeptides or other charged biomolecules.

In one embodiment, the solution that includes at least one cationic biomolecule, at least one anionic biomolecule, cationic and/or anionic ions, also includes biomolecules that are uncharged, wherein the cationic ions replace bound cations on the cation exchange layer of the water-splitting membrane and/or the anionic ions replace bound anions on the anion exchange layer of the water-splitting membrane, and the uncharged biomolecules pass through as a demineralized solution.

In some embodiments, the voltage applied to an electrochemical cell controls the degree of demineralization. In some embodiments, the flow rate of the incoming solution controls the degree of demineralization.

In one embodiment, the solution that includes at least one cationic biomolecule and at least one anionic biomolecule includes cationic and/or anionic ions, wherein the cationic ions replace bound cations on the cation exchange layer of the water-splitting membrane and/or the anionic ions replace bound anions on the anion exchange layer of the water-splitting membrane.

In some embodiments, the biomolecule-containing solution includes a plurality of different ions and/or salts. In various embodiments, ion(s) removed from a solution according to the methods provided herein include salt(s) and/or mineral(s).

In some embodiments, at least one ion replaces either bound cations on the cation exchange layer or bound anions on the anion exchange layer of the water-splitting membrane.

In some embodiments, the solution that includes at least one biomolecule and at least one ion includes a plurality of different ions and/or salts. For example, the plurality of different ions may include monovalent and/or multivalent ions. For example, the plurality of different ions may include cationic and/or anionic ions. In various embodiments, the plurality of different ions and/or salts includes, but is not limited to, Calcium (e.g., Ca²⁺), Magnesium (e.g., Mg²⁺), Phosphate (e.g., PO₄³⁻) Potassium (e.g., K⁺), Chloride (e.g., Cl⁻), Sodium (e.g., Na⁺), Zinc (e.g., Zn²⁺), Iron (e.g., Fe²⁺, Fe³⁺), Iodine (e.g., I⁻), Copper (e.g., Cu²⁺, Cu³⁺), Sodium Chloride (NaCl), Calcium Chloride (CaCl₂) and Magnesium Chloride (MgCl₂). In some embodiments, the plurality of ions includes at least one cationic ion and/or at least one anionic ion, wherein the at least one cationic ion replaces a bound cation on the cation exchange layer of the water splitting-membrane and/or the at least one anionic ion replaces a bound anion on the anion exchange layer of the water-splitting membrane.

In some embodiments, the solution that includes at least one biomolecule and at least on ion includes at least one charged biomolecule and at least one uncharged biomolecule. In some embodiments, at least a portion (e.g., at least about 10%, 20%, 30%, 40%, 50%, 60%, 70%, 80%, or 90%) of the charged biomolecule(s) flow through the electrochemical cell as unbound molecule(s). In some embodiments, substantially all (e.g., at least about 95%, 96%, 97%, 98%, 99%, 99.5, 99.8%, or 99.9%) of the uncharged biomolecule(s) flow through the cell as unbound molecule(s).

In some embodiments, the concentration, form (e.g., secondary, tertiary and/or quaternary structure), and/or biological activity of at least one charged and/or uncharged biomolecule, substantially all charged and/or uncharged biomolecules, or all charged and/or uncharged biomolecules remains unchanged or substantially unchanged in the solution that exits the electrochemical cell, with respect to the solution that entered the cell.

In one embodiment of the methods herein, the biomolecule-containing solution, e.g., the solution that includes at least one biomolecule and at least one ion, comprises, consists of, or consists essentially of whey (or a derivative of whey such as, but not limited to, ultrafiltration, microfiltration, or nanofiltration retentate or permeate), for example, at any pH (e.g., 1.0-14.0). In some embodiments, the solution that includes at least one biomolecule and at least one ion comprises, consists of, or consists essentially of deproteinized whey. In one embodiment, the whey includes ions (e.g., Na⁺, K⁺, Ca²⁺, Mg²⁺ Cl⁻, PO₄³⁻, and/or SO₄²⁻) and charged cationic and anionic polypeptides which bind the water-splitting ion exchange membrane with differing degrees of ionic or electrostatic attraction according to differences in their size, overall charge, charge density and surface charge distribution. In some embodiments of the methods described herein, polypeptides and ions both bind to the water-splitting membrane and are separated from other components of whey. In other embodiments, ions are separated in a first process to produce demineralized whey, and subsequently polypeptides are separated from the demineralized whey in a second process. In some embodiments, the ion and/or protein binding processes can be separated according to their respective competitive binding interactions with the resin. In some embodiments, ions have a competitive advantage to preferentially bind to the membrane due to their strong ionic binding or electrostatic attraction compared to the binding strength of the remaining charged biomolecules in solution (e.g., proteins). In some embodiments, this competitive ionic binding leads to displacement of any bound proteins in preference for smaller and highly charged ions present in the solution

In one embodiment, ions bind to the water-splitting ion exchange membrane with a higher competitive ionic binding (attraction) than the cationic and anionic polypeptides. In one embodiment, whey (or a derivative of whey such as, but not limited to, ultrafiltration retentate or permeate) is demineralized through preferential binding of ions to the water-splitting ion exchange membrane (e.g., by outcompeting other charged molecules in the solution), wherein the majority of the charged cationic and anionic polypeptides, uncharged fat and carbohydrate(s) (e.g., lactose), flow through the electrochemical cell as unbound molecules. Although not wishing to be bound by theory, the majority of the charged cationic and anionic polypeptides may flow through due to the competitive binding preference of the ions to the membrane due to their abundance and smaller size. This competitive ionic binding may lead to displacement of any bound proteins in preference for smaller and highly charged ions present in the solution.

In one embodiment, the whey (or derivative thereof) includes ions, wherein the cationic ions replace bound cations on the cation exchange layer of the water-splitting membrane and the anionic ions replace bound anions on the anion exchange layer of the water-splitting membrane. In some embodiments, the method includes reversing the polarity of the first and second electrodes, wherein the bound ions of whey are expelled from the membrane, and wherein the cationic and anionic ions exit through an outlet of the electrochemical cell as a regenerated solution that includes cationic and anionic ions of whey. In some embodiments, the solution used to expel the bound ions of whey from the membrane is an aqueous solution (e.g., at any pH (e.g., 1.0-14.0)). In one embodiment, the bound cationic and anionic ions of whey are replaced by H⁺ or OH⁻ produced in the water splitting reaction. In some embodiments, the cationic and anionic ions of whey are recovered as milk minerals, for example. In some embodiments, milk minerals are recovered in the regenerated solution in equivalent or substantially equivalent ratios to those in the starting solution of whey or a derivative thereof. In some embodiments, milk minerals are recovered in the regenerated solution at higher concentrations than in the solution that entered the electrochemical cell.

In some embodiments, whey (or a derivative thereof) includes fat, lactose, and/or charged and/or uncharged polypeptides, and substantially all (e.g., at least about 95%, 96%, 97%, 98%, 99%, 99.5, 99.8%, or 99.9%) of the fat and lactose and at least a portion (e.g., at least about 10%, 20%, 30%, 40%, 50%, 60%, 70%, 80%, or 90%) of the polypeptides (e.g., charged and/or uncharged polypeptides) flow through the electrochemical cell as unbound molecules. In some embodiments, the flow through from the electrochemical cell is a demineralized solution that contains substantially all (e.g., at least about 95%, 96%, 97%, 98%, 99%, 99.5, 99.8%, or 99.9%) of the fat lactose and lactose, and at least a portion (e.g., at least about 10%, 20%, 30%, 40%, 50%, 60%, 70%, 80%, or 90%) of the polypeptides (e.g., charged and/or uncharged polypeptides) of whey.

In some embodiments of the methods herein, the solution that contains one or more biomolecule(s) and one or more ion(s) for demineralization, can be at any pH (e.g., 1.0-14.0).

In some embodiments of the methods herein, the solution used to expel one or more ions from the water-splitting membrane after demineralization can be at any pH (e.g., 1.0-14.0).

In some embodiments, the solution that includes at least one biomolecule and at least one ion includes cationic ions, anionic ions, monovalent ions, and multivalent ions, and the cationic, anionic, monovalent, and multivalent ions bind to the cation exchange layer(s) and/or anionic exchange layer(s) on the water-splitting membrane(s).

In some embodiments, the solution that includes at least one biomolecule and at least one ion comprises, consists of, or consists essentially of a biological solution. In one embodiment, the biological solution is whey or a derivative thereof. In one embodiments, the biological solution is deproteinized whey.

In some embodiments, the solution that includes at least one biomolecule and at least one ion comprises, consists of, or consists essentially of a beverage. In some embodiments, the beverage is an alcoholic beverage. In one embodiment, the beverage is a wine or a derivative thereof, for example, a wine or derivative thereof that includes chloride, nitrate, phosphate, malate, tartrate, sulfite, sulfate, sodium, potassium, magnesium, calcium, manganese, cadmium, lead, copper, iron and/or mercury ions. In some embodiments, the wine or derivative thereof includes cationic and/or anionic polypeptides, uncharged polypeptides, mono-, di-, and/or oligosaccharides, sugar alcohols, and/or glycols, which flow through the first electrochemical cell in a demineralized wine solution. In some embodiments, the demineralized wine is a stabilized solution. In some embodiments, the removal of one or more ion from wine alters the pH and hence stabilizes the wine. In some embodiments, the demineralized wine includes a reduction in at least one ion, including chloride, nitrate, phosphate, malate, tartrate, sulfite, sulfate, sodium, potassium, magnesium, calcium, manganese, cadmium, lead, copper, iron and/or mercury. In some embodiments, the ions are recovered as minerals by reversing the polarity of the first and second electrodes, and wherein the bound ions are expelled from the membrane and exit through an outlet of the electrochemical cell.

In one embodiment of the methods herein, the biomolecule-containing solution comprises, consists of, or consists essentially of demineralized whey (e.g., at any pH (e.g., 1.0-14.0)). In one embodiment, the demineralized whey includes charged cationic and anionic polypeptides which bind to the water-splitting ion exchange membrane, wherein uncharged fat and carbohydrate(s) (e.g., lactose), flow through the electrochemical cell as unbound molecules. In one embodiment, the whey includes charged cationic and anionic polypeptides, wherein the cationic polypeptides replace bound cations on the cation exchange layer of the water-splitting membrane and the anionic polypeptides replace bound anions on the anion exchange layer of the water-splitting membrane. In some embodiments, the method includes reversing the polarity of the first and second electrodes, wherein the bound cationic and anionic polypeptides of whey are expelled from the membrane, and wherein the cationic and anionic polypeptides exit through an outlet of the electrochemical cell as a regenerated solution that includes cationic and anionic polypeptides of whey. In some embodiments, the method includes reversing the polarity of the first and second electrodes, wherein the bound cationic and anionic polypeptides of whey are expelled from the membrane using an aqueous solution (e.g., at any pH (e.g., 1.0-14.0)). In one embodiment, the bound cationic and anionic polypeptides of whey are replaced by H⁺ or OH⁻ produced in the water splitting reaction. In some embodiments, the fat and carbohydrate(s) (e.g., lactose) of whey do not foul the membrane as the solution flows through the electrochemical cell. In some embodiments, the protein(s) and ion(s) (e.g., Ca₂Po₄) of whey do not foul the membrane as they bind and subsequently are regenerated from the membrane within the electrochemical cell. In some embodiments, cationic and anionic polypeptides of whey in the regenerated solution are present at a total concentration that is about 2 to about 3 fold higher than in the whey solution that entered the electrochemical cell. In some embodiments, fat(s) from whey in the regenerated solution are present at a concentration that is about 10 fold lower than in the whey solution that entered the electrochemical cell. In some embodiments, the total amount of carbohydrate(s) (e.g., lactose) in the regenerated solution is less than 25% of the total amount present in the whey solution that entered the electrochemical cell.

In some embodiments, cationic and anionic ions of whey in the regenerated solution are present at a total concentration that is about 5 fold higher than in the whey solution that entered the electrochemical cell. In some embodiments, cationic and anionic ions of whey present in the demineralized solution are at a concentration that is at least about 10 fold lower than in the whey solution that entered the electrochemical cell.

In one embodiment of the methods herein, the biomolecule-containing solution comprises, consists of, or consists essentially of whey that has previously been treated by one or more prior methods, including but not limited to microfiltration, ultrafiltration, nanofiltration, reverse osmosis, electrodialysis, ion exchange and/or diafiltration, e.g., at any pH (e.g., 1.0-14.0).

In one embodiment of the methods herein, the solution that contains one or more biomolecule(s) and one or more ion(s) comprises, consists of, or consists essentially of demineralized whey, e.g., at any pH (e.g., 1.0-14.0), that has previously been treated by one or more prior method(s), including but not limited to microfiltration, ultrafiltration, nanofiltration, reverse osmosis, electrodialysis, ion exchange, and/or diafiltration. In one embodiment of the methods herein, the solution that contains one or more biomolecule(s) and one or more ions(s) comprises, consists of, or consists essentially of deproteinized whey (e.g., lactose, fats and ions) such as, but not limited to ultrafiltration permeate (UFP) (e.g., at any pH (e.g., 1.0-14.0)). In one embodiment, the deproteinized whey includes cationic and anionic ions, wherein the cationic ions replace bound cations on the cation exchange layer of the water-splitting membrane and the anionic ions replace bound anions on the anion exchange layer of the water-splitting membrane in a demineralization process. In one embodiment, the deproteinized whey further includes uncharged fat and carbohydrate(s) (e.g., lactose), wherein the fat and carbohydrate(s) (e.g., lactose) flow through the electrochemical cell as unbound molecules, e.g., as a demineralized solution. In some embodiments, the method includes reversing the polarity of the first and second electrodes, wherein the bound cationic and anionic ions of deproteinized whey are expelled from the membrane, exiting through an outlet of the electrochemical cell as a regenerated solution that includes cationic and anionic ions of deproteinized whey. In some embodiments, the method includes reversing the polarity of the first and second electrodes, wherein the bound ions from deproteinized whey are expelled from the membrane using an aqueous solution (e.g., at any pH (e.g., 1.0-14.0)). In one embodiment, the bound cationic and anionic ions of deproteinized whey are replaced by H⁺ or OH⁻ produced in the water splitting reaction. In some embodiments, the fat and carbohydrate(s) (e.g., lactose) of deproteinized whey do not foul the membrane as the solution flows through the electrochemical cell. In some embodiments, cationic and anionic ions of deproteinized whey in the regenerated solution are present at a total concentration that is at least about 5 fold higher than in the deproteinized whey solution that entered the electrochemical cell. In some embodiments, cationic and anionic ions of deproteinized whey in the demineralized solution are present at a concentration that is at least about 10 fold lower than in the deproteinized whey solution that entered the electrochemical cell.

In another aspect, a method is provided for demineralization of a solution that includes at least one biomolecule and at least one ion, followed by separation of charged biomolecules from uncharged biomolecules from the demineralized solution. One example of such a method includes recovery of cationic and/or anionic polypeptides from whey or a derivative thereof, although the same methodology may be used for demineralization, followed by separation of charged biomolecules, from any starting solution that contains ions and charged biomolecules.

In one embodiment, the method includes demineralizing whey or a derivative thereof, as described above, e.g., in a method comprising: applying a voltage to a first electrochemical cell that comprises: (a) a first housing that includes an inlet and an outlet; (b) first and second electrodes; (c) at least one first water-splitting ion exchange membrane between the first and second electrodes, wherein the water-splitting membrane includes: (i) a cation exchange layer facing the first electrode and including a bound cation; and (ii) an anion exchange layer facing the second electrode and including a bound anion; and (d) a solution that includes at least one biomolecule and at least one ion (e.g., whey or a derivative thereof), wherein the solution flows through a continuous channel from the inlet to the outlet of the cell and contacts the first and second electrodes and the cation and anion exchange layers of the water-splitting membrane(s), wherein at least one ion (e.g., ions of whey or a derivative thereof) binds to the cation exchange layer and/or the anion exchange layer(s) on the first water-splitting membrane(s), thereby causing demineralization of the solution by removing or reducing the concentration of the ion(s) (e.g., demineralized whey or a derivative thereof that includes fat, lactose, and uncharged polypeptides and charged (cationic and anionic)polypeptides of whey; and wherein the method further comprises: applying a voltage to a second electrochemical cell that includes: (a) a second housing that includes second inlet and a second outlet; (b) third and fourth electrodes; (c) at least one second water-splitting ion exchange membrane between the third and fourth electrodes, wherein the second water-splitting membrane includes: (i) a cation exchange layer facing the third electrode and comprising a bound cation; and (ii) an anion exchange layer facing the fourth electrode and comprising a bound anion; and (d) the demineralized solution (e.g., demineralized whey or a derivative thereof that includes fat, lactose, and uncharged polypeptides and charged (cationic and anionic) polypeptides of whey), wherein the demineralized solution flows through a continuous channel from the inlet to the outlet of the second electrochemical cell and contacts the third and fourth electrodes and the cation and anion exchange layers of the second water-splitting membrane; wherein cationic polypeptides bind to the cation exchange layer and/or anionic polypeptides bind to the anion exchange layer on the second water splitting membrane; and wherein the method further comprises reversing the polarity of the third and fourth electrodes, wherein the bound cationic and/or anionic polypeptides are expelled from the membrane, and exit through an outlet of the second electrochemical cell in a regenerated solution. In some embodiments, the first electrochemical cell and the second electrochemical cell are the same. In other embodiments, the first electrochemical cell and the second electrochemical cell are different. In some embodiments, the flow rate through the first electrochemical cell is higher than the flow rate through the second electrochemical cell. In one embodiment, the flow rate through the second electrochemical cell is about 25% to about 50% lower than the flow rate through the second electrochemical cell.

In another aspect, a system is provided for separation of a biomolecule from a solution, including: (a) a housing comprising an inlet and an outlet; (b) first and second electrodes;

(c) at least one water-splitting ion-exchange membrane between the first and second electrodes, wherein the water-splitting membrane includes: (i) a cation exchange layer facing the first and second electrode and comprising a bound cation; and (ii) an anion exchange layer facing the second electrode and comprising a bound anion; and (d) a solution that includes the biomolecule, wherein the system is configured such that the solution flows through a continuous channel from the inlet to the outlet of the cell and contacts the first and second electrodes and the cation and anion exchange layers of the water-splitting membrane, and
wherein the system is configured such that when a voltage is applied to the electrochemical cell, the biomolecule binds to the cation exchange layer or the anion exchange layer on the water-splitting membrane or flows through the electrochemical cell as an unbound molecule. In some embodiments, the system is configured such that when the polarity of the first and second electrodes is reversed, the bound charged biomolecule is expelled from the membrane and exits through the outlet of the electrochemical cell in a regeneration solution.

In another aspect, a system is provided for demineralization of a solution that includes at least one biomolecule and at least one ion, including: (a) a housing comprising an inlet and an outlet; (b) first and second electrodes; (c) at least one water-splitting ion-exchange membrane between the first and second electrodes, wherein the water-splitting membrane includes (i) a cation exchange layer facing the first and second electrode and comprising a bound cation; and (ii) an anion exchange layer facing the second electrode and comprising a bound anion; (d) a solution that comprises the at least one biomolecule and at least one ion,

wherein the system is configured such that the solution flows through a continuous channel from the inlet to the outlet of the cell and contacts the first and second electrodes and the cation and anion exchange layers of the water-splitting membrane, and wherein the system is configured such that when a voltage is applied to the electrochemical cell, the at least one ion binds to the cation exchange layer or the anion exchange layer on the water-splitting membrane, thereby causing demineralization of the solution by removing or reducing the concentration of at least one ion. In some embodiments, the system is configured such that when the polarity of the first and second electrodes is reversed, the at least one bound ion is expelled from the membrane and exits through the outlet of the electrochemical cell in a regeneration solution.

In some embodiments of the methods and systems herein, a solution that contains one or more biomolecule(s) or a solution that contains at least one biomolecule and at least one ion, for use in a method for separation of a biomolecule or demineralization of a solution, can be at any pH (e.g., 1.0-14.0). For example, the biomolecule-containing solution may be at a pH selected from about 1.0 to about 1.5, about 1.5 to about 2.0, about 2.0 to about 2.5, about 2.5 to about 3.0, about 3.0 to about 3.5, about 3.5 to about 4.0, about 4.0 to about 4.5, about 4.5 to about 5.0, about 5.0 to about 5.5, about 5.5 to about 6.0, about 6.0 to about 6.5, about 6.5 to about 7.0, about 7.0 to about 7.5, about 7.5 to about 8.0, about 8.0 to about 8.5, about 8.5 to about 9.0, about 9.0 to about 9.5, about 9.5 to about 10.0, about 10.0 to about 10.5, about 10.5 to about 11.0, about 11.0 to about 11.5, about 11.5 to about 12.0, about 12.0 to about 12.5, about 12.5 to about 13.0, about 13.0 to about 13.5, about 13.5 to about 14.0, about 1.0 to about 2.0, about 1.5 to about 2.5, about 2.0 to about 3.0, about 2.5 to about 3.5, about 3.0 to about 4.0, about 3.5 to about 4.5, about 4.0 to about 5.0, about 4.5 to about 5.5, about 5.0 to about 6.0, about 5.5 to about 6.5, about 6.0 to about 7.0, about 6.5 to about 7.5, about 7.0 to about 8.0, about 7.5 to about 8.5, about 8.0 to about 9.0, about 8.5 to about 9.5, about 9.0 to about 10.0, about 9.5 to about 10.5, about 10.0 to about 11.0, about 10.5 to about 11.5, about 11.0 to about 12.0, about 11.5 to about 12.5, about 12.0 to about 13.0, about 12.5 to about 13.5, about 13.0 to about 14.0, or any of about 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, or 14.0.

In some embodiments of the methods and systems herein, the solution (regeneration solution) used to expel the biomolecule(s) or ion(s) from a water-splitting membrane can be at any pH (e.g., 1.0-14.0). For example, the regeneration solution may be at a pH selected from about 1.0 to about 1.5, about 1.5 to about 2.0, about 2.0 to about 2.5, about 2.5 to about 3.0, about 3.0 to about 3.5, about 3.5 to about 4.0, about 4.0 to about 4.5, about 4.5 to about 5.0, about 5.0 to about 5.5, about 5.5 to about 6.0, about 6.0 to about 6.5, about 6.5 to about 7.0, about 7.0 to about 7.5, about 7.5 to about 8.0, about 8.0 to about 8.5, about 8.5 to about 9.0, about 9.0 to about 9.5, about 9.5 to about 10.0, about 10.0 to about 10.5, about 10.5 to about 11.0, about 11.0 to about 11.5, about 11.5 to about 12.0, about 12.0 to about 12.5, about 12.5 to about 13.0, about 13.0 to about 13.5, about 13.5 to about 14.0, about 1.0 to about 2.0, about 1.5 to about 2.5, about 2.0 to about 3.0, about 2.5 to about 3.5, about 3.0 to about 4.0, about 3.5 to about 4.5, about 4.0 to about 5.0, about 4.5 to about 5.5, about 5.0 to about 6.0, about 5.5 to about 6.5, about 6.0 to about 7.0, about 6.5 to about 7.5, about 7.0 to about 8.0, about 7.5 to about 8.5, about 8.0 to about 9.0, about 8.5 to about 9.5, about 9.0 to about 10.0, about 9.5 to about 10.5, about 10.0 to about 11.0, about 10.5 to about 11.5, about 11.0 to about 12.0, about 11.5 to about 12.5, about 12.0 to about 13.0, about 12.5 to about 13.5, about 13.0 to about 14.0, or any of about 1.0, 1.5, 2.0, 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, 12.0, 12.5, 13.0, 13.5, or 14.0.

In some embodiments of the methods and systems herein, e.g., for separation of biomolecules and/or demineralization of solutions, the water-splitting membrane(s) of the electrochemical cell is (are) rolled in a spiral arrangement to form a cylindrical shape. In one embodiment, the first or second electrode includes a cylinder that encloses the spiral arrangement of water-splitting membrane(s). In some embodiments, influent flowing into the inlet of the cell flows past both the cation and anion exchange layer surfaces of the water-splitting membrane(s) in the direction of the spiral.

In some embodiments of the methods and systems herein, e.g., for separation of biomolecules and/or demineralization of solutions, the water-splitting ion exchange membrane(s) include(s) a bipolar double membrane that includes a first membrane and a second membrane, wherein the first membrane includes the cation exchange layer and the second membrane includes the anion exchange layer. In one embodiment, the cation exchange layer and the anion exchange layer abut one another and are in contact along at least a portion of their lengths, thereby forming an interface for water splitting.

In some embodiments of the methods and systems herein, e.g., for separation of biomolecules and/or demineralization of solutions, the anion and/or cation exchange layer(s) of the water-splitting ion exchange membrane(s) include(s) an exposed textured surface including a pattern of texture features that includes spaced apart peaks and valleys.

In some embodiments of the methods and systems herein, e.g., for separation of biomolecules and/or demineralization of solutions, the cation exchange layer is constructed with a strong acid cation resin in combination with a base anion layer constructed with a weak or strong base resin. In some embodiments the cation exchange layer is constructed with a weak acid cation resin in combination with a base anion layer constructed with a weak or strong base resin.

In some embodiments of the methods and systems herein, e.g., for separation of biomolecules and/or demineralization of solutions, the electrochemical cell includes two or more water-splitting membranes that contain the same or different functional groups, and/or the same or different ion exchange capacities.

In another aspect, a protein powder is provided that includes cationic and anionic polypeptides that have been separated from lactose, fat and ions of whey (or a derivative of whey including but not limited to ultrafiltration retentate) according to a method described herein.

In another aspect, a lactose powder is provided that comprises, consists of, or consists essentially of lactose (e.g., ground lactose crystals) that has been separated from protein and fat of whey in a concentrate prepared by a previously established protein separation method, including but not limited to ultrafiltration, and subsequently demineralized according to a method described herein. In some embodiments, a lactose powder is provided that includes about 50% to about 99% lactose by weight.

In another aspect, a milk mineral powder is provided that includes cationic and anionic ions that have been separated from protein, lactose and fat of whey (or a derivative of whey including but not limited to ultrafiltration retentate and/or permeate) according to a method described herein.

In another aspect, a specific protein powder is provided that includes a cationic or anionic protein (e.g., lactoferrin) that has been separated from all other proteins, fat, lactose and minerals present in whey (or a derivative of whey including but not limited to ultrafiltration retentate and/or permeate) according to a method described herein.

In another aspect, a demineralized and/or stabilized wine that has one or more ion removed, according a method described herein, is provided.

### BRIEF DESCRIPTION OF THE DRAWINGS

FIG. 1 shows schematically a method for demineralization of a solution that contains one or more biomolecule(s) and one or more ion(s) such as whey (or derivative of whey such as but not limited to, ultrafiltration permeate or ultrafiltration retentate) as described in Example 1.

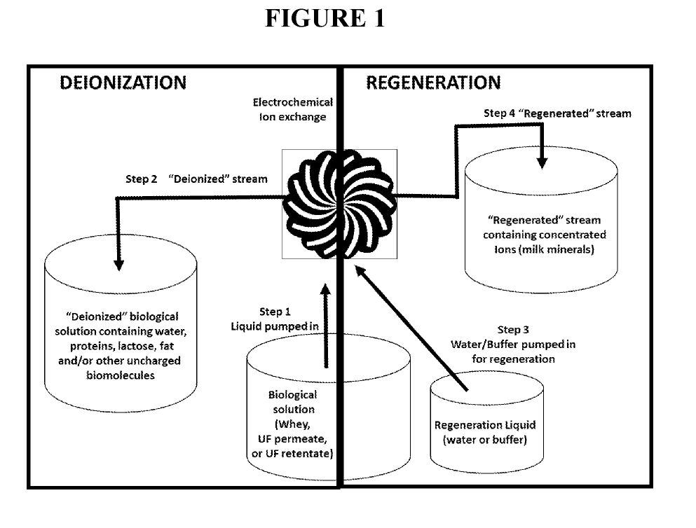

FIG. 2 shows schematically a method for separating charged biomolecules (e.g., proteins) from a demineralized solution containing charged and uncharged biomolecules (e.g., fat and lactose in whey (e.g., demineralized whey), or a derivative of whey (e.g., demineralized derivative of whey) such as but not limited to, ultrafiltration retentate) as described in Example 2.

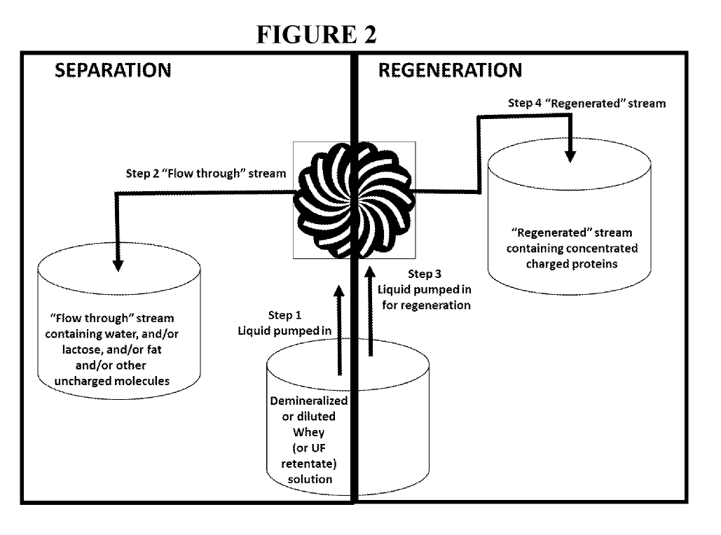

FIG. 3 shows schematically a method for controlled removal of ions from a solution containing charged and uncharged biomolecules (e.g., wine) as described in Example 3.

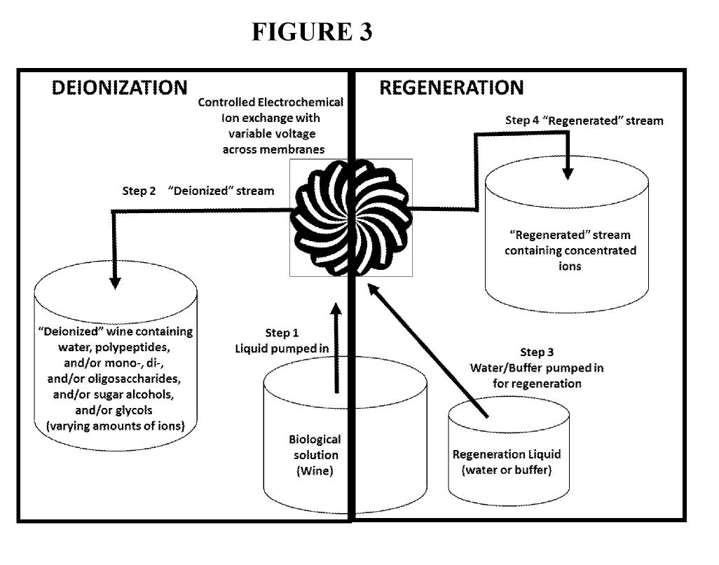

FIG. 4 shows schematically a method for separation of a specific protein from a demineralized solution that contains one or more biomolecule(s) such as demineralized whey (or derivative of whey such as but not limited to ultrafiltration retentate) using targeted binding as described in Example 4.

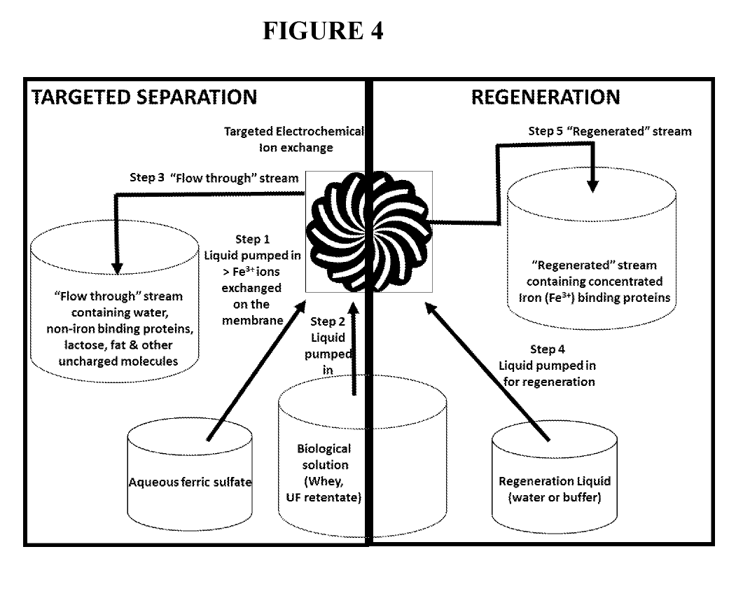

### DETAILED DESCRIPTION

Methods and systems for separation and/or purification of biomolecules from a solution are provided. Methods and systems for separation and/or purification of biomolecules and ions from a solution are also provided. Methods and systems for demineralization of a solution that contains one or more biomolecule(s) and one or more ion(s) are also provided.

Exemplary, but non-limiting embodiments are depicted below:

In some embodiments, a solution which contains one or more biomolecule(s) and one or more ion(s) can be demineralized by controlling operational parameters such as, but not limited to, flow rate, membrane composition (cation and/or anion resins used for extrusion of the water-splitting membrane) and pH. Although not wishing to be bound by theory, during demineralization, ions may have a competitive advantage to preferentially bind to the membrane due to their smaller size, abundance and/or strong ionic binding or electrostatic attraction compared to the binding strength of the remaining charged biomolecules in solution (e.g., proteins). This competitive ionic binding may lead to displacement of any bound proteins in preference for smaller and highly charged ions present in the solution. In some embodiments, the demineralized solution containing one or more biomolecule(s) can further be subsequently processed by controlling operational parameters such as, but not limited to, flow rate, membrane composition (cation and/or anion resins used for extrusion of the water-splitting membrane) and pH, to separate charged biomolecule(s) from uncharged biomolecule(s). Methods and systems are described for demineralization and/or separation of biomolecules from biomolecule-containing solutions.

The methods and systems disclosed herein include an electrochemical cell that contains at least one bipolar ion exchange membrane that is capable of water splitting and is situated between two electrodes, and to which both cationic and anionic biomolecules and/or ions bind when an electrical voltage is applied to the cell. Bound biomolecules and/or bound ions may be removed from the membrane by reversing the polarity of the electrodes. In some embodiments, both cationic and anionic biomolecules and/or ions are recovered simultaneously from a solution using the methods and systems described herein. In some embodiments, polypeptides may be recovered in native (e.g., non-denatured) configurations. In some embodiments, a specific cationic or anionic biomolecule (e.g., a polypeptide) is bound and purified from a solution using the methods and systems described herein. In some embodiments, both cationic and anionic ions are recovered simultaneously from a solution that contains one or more biomolecule(s) and one or more ion(s) using the methods and systems described herein. In some embodiments, the ions may be recovered in substantially their naturally occurring states and ratios (e.g., milk mineral salt ratios found in whey).

### Definitions

Numeric ranges provided herein are inclusive of the numbers defining the range.

Unless otherwise indicated, nucleic acids are written left to right in 5′ to 3′ orientation; amino acid sequences are written left to right in amino to carboxy orientation, respectively.

“A,” “an” and “the” include plural references unless the context clearly dictates otherwise.

“Biomolecule” refers to a molecule that is produced by a living system (e.g., animal plant, fungus, bacterium, virus), including but not limited to polypeptides, polynucleotides, mono- and polysaccharides, lipids, amino acids, nucleotides, vitamins, primary metabolites, secondary metabolites, and natural products. In one embodiment, “biomolecule” refers to a recombinantly expressed polypeptide, e.g., a polypeptide produced from a recombinant construct with or without a tag, such as a his tag or other tag. “Ions” refer to an atom or molecule in which the total number of electrons is not equal to the total number of protons, giving the atom a net positive or negative electrical charge. In chemical terms, if a neutral atom loses one or more electrons, it has a net positive charge and is known as a cation. If an atom gains electrons, it has a net negative charge and is known as an anion. An ion consisting of a single atom is an atomic or monatomic ion; if it consists of two or more atoms, it is a molecular or polyatomic ion.

“Ion” refers to an atom or molecule in which the total number of electrons is not equal to the total number of protons, giving the atom or molecule a net positive or negative electrical charge. In chemical terms, if a neutral atom or molecule loses one or more electrons, it has a net positive charge and is known as a cation. If a neutral atom or molecule gains electrons, it has a net negative charge and is known as an anion. An ion consisting of a single atom is an atomic or monatomic ion; if it consists of two or more atoms, it is a molecular or polyatomic ion.

“Mineral” refers to naturally-occurring inorganic elements, typically having a crystalline structure.

“Milk minerals” refers to minerals or milk salts, which include, but are not limited to, cations and anions that are in milk, for example, calcium, phosphate, magnesium, sodium, potassium, citrate, and chlorine, typically at concentration of about 5 to about 40 mM, and Vitamins A, B6, B12, C, D, K, E, thiamine, niacin, biotin, riboflavin, folates, and pantothenic acid, classified as milk trace elements or minerals.

“Salts” refer to ionic compounds that can result from the neutralization reaction of an acid and a base. They are composed of related numbers of cations (positively charged ions) and anions (negative ions) so that the product is electrically neutral (without a net charge)

An “ion exchange membrane” is a structure that includes a cation exchange surface and/or an anion exchange surface. In one embodiment, the ion exchange membrane contains a cation exchange surface and an anion exchange surface in combination. In some embodiments, the ion exchange membrane, also termed “bipolar,” “double,” or “laminar,” contains anion and cation exchange surfaces on opposite sides of the membrane, e.g., abutting anion and cation exchange surfaces on opposite sides of the membrane. In one embodiment, the ion exchange membrane is capable of “water splitting,” such that in a sufficiently high electric field produced by application of a voltage to two electrodes, water is dissociated or “split” into component ions H⁺ and OH⁻. In some embodiments, the water-splitting membrane contains anion and cation exchange surfaces on opposite sides of the membrane, e.g., abutting anion and cation exchange surfaces on opposite sides of the membrane, and the dissociation of water occurs most efficiently at the boundary between the cation and anion exchange surfaces, with the resultant H⁺ and OH⁻ ions migrating through the ion exchange surfaces in the direction of the electrode having an opposite polarity (e.g., H⁺ migrates toward the negative electrode and OH⁻ migrates toward the positive electrode). In some embodiments, an anion or cation exchange surface may be an anion or cation exchange layer on the ion exchange (e.g., water-splitting) membrane. “Cation exchange” refers to a material that exchanges positively-charged ions or molecules (“cations”) on the surface of an immobile material for cations in a solution, e.g., with no permanent change to the immobile exchange material. For example, a cation exchange material may contain an acidic group (e.g., —COOM, —SO₃M, —PO₃M, or —C₆H₄OM, where M is a cation (e.g., hydrogen, sodium calcium, or copper ion)). In some embodiments, an ion exchange membrane (e.g., a membrane capable of water splitting) as described herein includes a strong acid cation exchange surface (e.g., a strong acid cation exchange layer on the membrane). Strong acids are highly ionized in both the acid (e.g., R—SO₃H) and salt (e.g., R—SO₃Na) forms. The hydrogen and sodium forms of strong acids are highly dissociated and the exchangeable Na⁺ and H⁺ ions are readily available for exchange over the entire pH range. A nonlimiting example of a strong acid cation exchange group is a sulfonic acid group on the surface of the ion-exchange membrane (—SO₃M). In some embodiments, a cation exchange group (e.g., a sulfonic acid group) may interact with basic groups in a biomolecule, such as histidine, lysine and arginine side chains of a net-positively charged polypeptide. In order to keep the basic groups (e.g., basic side chains of a polypeptide) protonated, the mobile phase may be buffered to maintain the pH below 6 or 7. At higher pH, the basic groups may deprotonate, decreasing retention. In some embodiments, an ion exchange membrane (e.g., a membrane capable of water splitting) as described herein includes a weak acid cation exchange surface (e.g., a weak acid cation exchange layer on the membrane). A nonlimiting example of a weak acid cation exchange group is a carboxylic acid (COOH). The degree of dissociation of a weak acid is strongly influenced by the solution pH.

“Anion exchange” refers to a material that exchanges negatively-charged ions or molecules (“anions”) on the surface of an immobile material for anions in a solution, e.g., with no permanent change to the immobile exchange material. For example, an anion exchange material may contain a basic group (e.g., —NR₃A, —NR₂HA, —PR₃A, —SR₂A, or C₅H₅NHA, where A is an anion (e.g., hydroxide, bicarbonate, or sulfonate)). In some embodiments, an ion exchange membrane (e.g., a membrane capable of water-splitting) as described herein includes a strong base anion exchange surface (e.g., a strong base anion exchange layer on the membrane). A nonlimiting example of a strong base anion exchange group is a quaternary ammonium group, (—NR₃A). In some embodiments, an anion exchange group (e.g., a quaternary ammonium group) may interact with acidic groups in a biomolecule, such as aspartic acid or glutamic acid side chains of a net-negatively charged polypeptide. In order to keep the acidic groups (e.g., acidic side chains of a polypeptide) deprotonated, the mobile phase may be buffered to maintain the pH above 4.4. At lower pH, the acidic groups may protonate, decreasing retention. Strong bases are readily available for exchange over the entire pH range. In some embodiments, an ion exchange membrane (e.g., a membrane capable of water-splitting) as described herein, includes a weak base anion exchange surface (e.g., a weak base anion exchange layer on the membrane). The degree of ionization of a weak base is strongly influenced by solution pH.

“Ionic Binding” refers to formation of a type of chemical bond that involves the electrostatic attraction between oppositely charged ions. These ions are atoms that have lost one or more electrons (cations) or atoms that have gained one or more electrons (anions). Electrostatic attraction between ions of opposite charge (cations and anions) may result in an ionic bond.

As used herein, “polypeptide” refers to a composition comprised of amino acids and recognized as a protein by those of skill in the art. The conventional one-letter or three-letter code for amino acid residues is used herein. The terms “polypeptide” and “protein” are used interchangeably herein to refer to polymers of amino acids of any length. The polymer may be linear or branched, it may comprise modified amino acids, and it may be interrupted by non-amino acids. The terms also encompass an amino acid polymer that has been modified naturally or by intervention; for example, disulfide bond formation, glycosylation, lipidation, acetylation, phosphorylation, or any other manipulation or modification, such as conjugation with a labeling component. Also included within the definition are, for example, polypeptides containing one or more analogs of an amino acid (including, for example, unnatural amino acids, etc.), as well as other modifications known in the art.

As used herein, the term “polynucleotide” refers to a polymeric form of nucleotides of any length and any three-dimensional structure and single- or multi-stranded (e.g., single-stranded, double-stranded, triple-helical, etc.), which contain deoxyribonucleotides, ribonucleotides, and/or analogs or modified forms of deoxyribonucleotides or ribonucleotides, including modified nucleotides or bases or their analogs. Because the genetic code is degenerate, more than one codon may be used to encode a particular amino acid, and the present invention encompasses polynucleotides which encode a particular amino acid sequence. Any type of modified nucleotide or nucleotide analog may be used, so long as the polynucleotide retains the desired functionality under conditions of use, including modifications that increase nuclease resistance (e.g., deoxy, 2′-O-Me, phosphorothioates, etc.). Labels may also be incorporated for purposes of detection or capture, for example, radioactive or nonradioactive labels or anchors, e.g., biotin or fluorescent labels. The term polynucleotide also includes peptide nucleic acids (PNA). Polynucleotides may be naturally occurring or non-naturally occurring. The terms “polynucleotide,” “nucleic acid,” and “oligonucleotide” are used herein interchangeably. Polynucleotides may contain RNA, DNA, or both, and/or modified forms and/or analogs thereof. A sequence of nucleotides may be interrupted by non-nucleotide components. One or more phosphodiester linkages may be replaced by alternative linking groups. These alternative linking groups include, but are not limited to, embodiments wherein phosphate is replaced by P(O)S (“thioate”), P(S)S (“dithioate”), (O)NR.sub.2 (“amidate”), P(O)R, P(O)OR′, CO or CH.sub.2 (“formacetal”), in which each R or R′ is independently H or substituted or unsubstituted alkyl (1-20 C) optionally containing an ether (—O—) linkage, aryl, alkenyl, cycloalkyl, cycloalkenyl or araldyl. Not all linkages in a polynucleotide need be identical. Polynucleotides may be linear or circular or comprise a combination of linear and circular portions.

“Whey” refers to the liquid solution remaining after milk has been curdled (coagulated protein or casein), typically by, but not limited to, addition of enzymes (e.g., rennet), acids or salts. In its raw form, whey contains proteins, fat, cholesterol, vitamins, minerals, and lactose (milk sugar). “Whey” herein may also refer to a derivative of whey, such as pre-processed whey, including, but not limited to, ultrafiltration retentate or permeate.

“Deproteinized whey” refers to the liquid solution remaining after some portion of the whey proteins have been removed/separated from whey (using a process such as, but not limited to ultrafiltration or ion exchange). This solution includes carbohydrates (e.g., lactose (“milk sugar”)), lipids, and milk minerals (ions), and may also contain a small portion of whey proteins.

“Lactose” refers to the disaccharide carbohydrate formed by the condensation of glucose and galactose to give a β-(1→4) linked product, which is present in milk and whey.

“Demineralization” refers to the process of removing some portion of the cationic and/or anionic monovalent and/or multivalent minerals (ions) and/or mineral salts from a solution. Demineralization grades are determined by the percentage of total ions removed from a solution (e.g., D50 refers to a 50% reduction of ions compared to the pretreated source solution).

“Ultra/Micro/Nano-filtration” refers to membrane filtration processes in which forces such as pressure or concentration gradients leads to the separation of molecules through a semipermeable membrane primarily based on size. Suspended solids and solutes of higher molecular weight than the filter cut-off are retained in the retentate, while water and lower molecular weight solutes pass through the membrane in the permeate.

“Retentate” refers to suspended solids in a filtration process that do not cross the membrane due to their size being larger than the filter cut-off. The pore size of the membrane determines which molecules are retained and which molecules pass through.

“Permeate” refers to suspended solids in a filtration process that cross the membrane due to their size being smaller than the filter cut-off. The pore size of the membrane determines which molecules are retained and which molecules pass through as permeate.

“Conductivity” refers to specific conductance of an electrolyte solution as a measure of its ability to conduct electricity. The SI unit of conductivity is Siemens per meter. A conductivity measurement provides a fast, inexpensive and reliable way of measuring the ionic content in a solution that contains one or more biomolecule(s) and one or more ion(s). Conductivity is linked directly to the total dissolved solids (T.D.S.) present in a solution. For reference, typical drinking water lies within the range of 5-50 μS/cm, while sea water is about 5 mS/cm (i.e., sea water's conductivity is one million times higher than that of deionized water). The typical conversion of conductivity to a total dissolved solids (TDS) value is done assuming that the solid in solution is sodium chloride, and therefore 1 μS/cm is then assumed to be an equivalent of about 0.6 mg of NaCl per kg of water.

The term “derived from” encompasses the terms “originated from,” “obtained from,” “obtainable from,” “isolated from,” and “created from,” and generally indicates that one specified material finds its origin in another specified material or has features that can be described with reference to the another specified material.

A “solution” refers to a homogenous or substantially homogeneous mixture in which the particles of one or more substance(s) (the solute(s)), are distributed uniformly or substantially uniformly throughout another substance (the solvent). A solution as described herein can be at any pH (e.g., 1.0-14.0).

A “biological solution” refers to a solution that is derived from a biological source or origin.

A “stabilized solution” (including, but not limited to, a stabilized beverage, such as stabilized wine), refers to a solution with decreased volatility, for example, as a result of removing particles and/or ions that may cause unwanted chemical changes in the solution).

A “his tag” refers to a polyhistidine sequence, for example, six histidine (His) residues. In some embodiments, a his tag may be located at the N- or C-terminus of a protein, encoded by repetitive histidine codons (e.g., CAT or CAC) right after the START or before the STOP codon.

“Flow rate” refers to the volume of fluid that flows through a measured distance over a specific unit of time (e.g., liters per minute).

“Polarity” refers to electrical polarity (positive and negative), which is present in electrical circuits. Electrons flow from the negative pole to the positive pole. In a direct current (DC) circuit, one pole is negative, the other pole is positive, and electrons flow in one direction only. In an alternating current (AC) circuit, flow of electric charge periodically reverses direction as the two poles alternate between negative and positive.

“Reverse polarity” refers to switching the negative electrode (in a given electrochemical cell as described herein), to positive and switching the positive electrode to negative. By doing so, the electrostatic bond between a cation exchange layer and an attached cation or an anion exchange layer and an attached anion can be broken or displaced.

“Denaturation” refers to a process in which a biologically active molecule such as a protein or nucleic acid loses its native state or configuration by disruptions in its quaternary, tertiary and/or secondary structures. Denaturation may occur due to the application of an external stress or compound such as exposure to a strong acid or base, a salt (e.g., a concentrated inorganic salt), an organic solvent (e.g., alcohol or chloroform), radiation or heat, causing a range of issues from loss of solubility to protein aggregation and/or precipitation. In some cases, denaturation is reversible (e.g., a protein can fold back into its native state when the denaturing influence is removed). This process is referred to as “renaturation.”

“Precipitation” refers to the formation of a solid substance within a solution. For example, a substance may precipitate from solution due to a change in the composition of the solvent, which diminishes the solubility of the substance. Precipitation of proteins may be effected by a change in the pH of a biological solution. Precipitation of proteins due to change in a solution's pH may be governed by the protein's isoelectric point (pI). At a solution pH above the pI of a protein, it is negatively charged; at a solution pH below the pI of a protein, it is positively charged, and at a pH equal to the pI of the protein, the net primary charge of a protein becomes zero, at which point the protein may denature and precipitate out of solution.

“Biologically active” refers to a biomolecule, such as a protein, that is capable of performing the function that it typically performs in a biological system (e.g., including but not limited to structural, enzymatic, or regulatory functions). The “native state” of a biomolecule, such as a protein, is its properly folded and/or assembled form, which is operative and functional. For example, if a protein unfolds from its native configuration or becomes compromised in some way (e.g., denatured), it may no longer be able to perform its primary function and may be considered to have lost its biological or native activity.

“Membrane” refers to a permeation-selective barrier (e.g., porous, non-porous, symmetric, neutral or charged), which may effect separation under the influence of a driving force (e.g., pressure difference, concentration difference, electrical potential difference). Components can either pass through the barrier (“permeate”) or be retained (“rententate”), allowing selective separation of components based on some criteria (e.g., size or charge).

### Electrochemical Cell

An electrochemical cell is provided for separation and/or purification of biomolecules as disclosed herein. In one embodiment, the electrochemical cell contains:

(a) a housing that includes at least one inlet and at least one outlet;
(b) a first electrode and a second electrode;
(c) at least one water-splitting ion exchange membrane capable of water splitting, between the first and second electrodes, with a cation exchange surface facing the first electrode and an anion exchange surface facing the second electrode;
(d) at least one channel from the inlet to the outlet, configured for a solution to flow from the inlet to the outlet of the cell, and configured such that the solution flows in contact with at least one of the cation and anion exchange surfaces of the water-splitting membrane.

In some embodiments, the water-splitting ion exchange membrane(s) is (are) bipolar, with the cation exchange surface on the opposite side of the membrane from the anion exchange surface.

In some embodiments, the solution channel is continuous or substantially continuous from the inlet to the outlet of the electrochemical cell. In some embodiments, the channel is configured such that the solution flowing through the channel is in contact with both the cation exchange surface and the anion exchange surface of the membrane.

When an electrical voltage is applied to the electrodes, positively-charged molecules in a solution that is flowing through the channel, bind to the cation exchange surface of the membrane and negatively-charged molecules in the solution bind to the anion exchange surface of the membrane. Uncharged molecules may flow through the outlet of the cell without binding to either the cation exchange surface or the anion exchange surface of the membrane.

In some embodiments, the cell includes a plurality of water-splitting ion exchange membranes, configured such that the cation exchange surface of each membrane faces the first electrode and the anion exchange surface of each membrane faces the second electrode.

In some embodiments, the cell includes a plurality of channels that flow from a single inlet to a single outlet in the cell, or that flow from a plurality of inlets to a plurality of outlets, with each channel flowing from an inlet to an outlet of the cell and configured such that the solution flows in contact with at least one of the cation and anion exchange surfaces of one of a plurality of water-splitting membranes. In some embodiments, each channel is configured such that the solution flows in contact with both the cation exchange and anion exchange surfaces of one of a plurality of water-splitting membranes.

A flow controller, such as a pump, and/or an external flow sensor, may be used to control the flow rate of the solution from a solution source through the channel and into a treated solution container. In embodiments in which the electrochemical cell includes a plurality of solution channels, the treated solution from each channel may flow into the same or separate treated solution containers.

The electrodes may be powered by a voltage supply that supplies a voltage across the electrodes (e.g., anode and cathode electrodes). Exemplary, nonlimiting electrical parameters for powering the cell include 100-120 vac (volts alternating current), 50/60 Hz (cycles per second frequency), and 6 Amps (current).

Electrodes may be constructed of any suitable material for use in the methods described herein for separation and/or purification of biomolecules. For example, electrodes may be fabricated from an electrically-conductive material, such as a metal or metal-containing material, which is resistant to corrosion in a biomolecule-containing solution from which separation and/or purification of at least one biomolecule is desired. Non-limiting examples of suitable materials for construction of electrodes include copper, aluminum, or steel cores, which may be coated with a corrosion-resistant material, such as platinum, titanium, or niobium. The shape of the electrodes may be adapted to the design of the electrochemical cell and the conductivity of the biomolecule-containing solutions which will flow through the cell. Desirably, the electrodes should provide a uniform voltage across the surfaces of the water-splitting ion exchange membrane(s).

In some embodiments, a single solution stream may be introduced into one inlet and exit via one outlet. This is in contrast to electrodialysis systems that contain monopolar ion exchange membranes or water-splitting membranes and have separate waste and product solution streams. Electrodialysis systems in continuous operation require two separate solution streams, a product stream from which ions are removed and a waste stream into which the ions are deposited. The separation of the two solution streams is often provided by monopolar ion exchange membranes. In some embodiments, the electrochemical cell does not contain a monopolar ion exchange membrane, e.g., does not contain a monopolar ion exchange membrane between adjacent water-splitting membranes. The batch mode operation of the electrochemical cell described herein eliminates the need for monopolar ion exchange membranes to separate solution streams.

In some embodiments, a plurality of bipolar water-splitting membranes, with cation and anion exchange surfaces on opposite sides of the membranes, is configured with their cation exchange surfaces facing the first electrode and their anion exchange surfaces facing the second electrode. Thus, all water-splitting membranes within a cell may be operating in either production mode (e.g., deionization and binding of charged molecules) or regeneration mode. With all cation and anion exchange surfaces of the membranes facing the first and second electrodes, respectively, the electric field will have a direction which is transverse or normal, or substantially transverse or normal, to the surfaces of the water-splitting membranes, resulting in a water-splitting reaction that is perpendicular to the surfaces of the membranes and providing the shortest pathway through the membrane to increase the efficiency of ion exchange. Alternatively, ions may be drawn in from solution or into the ion exchange surfaces of the water-splitting membranes normal or substantially normal to their surfaces. This may provide full utilization of the ion exchange materials by preventing divergent electric fields or current fluxes that would bypass portions of the ion exchange surfaces. A uniform electric field or current flux that is directly transverse to the ion exchange surfaces of the membranes provides the most uniform current distribution and ion flow pattern through the water-splitting membranes.

In some embodiments, a plurality of water-splitting ion exchange membranes in an electrochemical cell include the same or different functional groups, and/or may include the same or different ion exchange capacities.

In one embodiment, the electrochemical cell contains one or more water-splitting membranes in a spiral wrapped arrangement. For example, at least one water-splitting membrane may be wrapped or rolled with an adjacent separator or spacer within a housing that is in a circular or substantially circular shape. In one embodiment, one of the electrodes (e.g., first or second electrode) may be configured in the center of the spirally-wrapped membrane(s) and the other electrode may be configured at the outside of the membrane spiral. A biomolecule-containing solution may enter the cell via an inlet through the outer wall of the housing and may flow through solution channels that simultaneously contact the anion exchange and cation exchange surfaces of the water-splitting ion exchange membrane(s), exiting through one or more outlet(s), for example, an outlet located at the top of the cell. In one embodiments, the solution channel(s) are continuous from the inlet to the outlet of the cell.

Nonlimiting examples of electrochemical cells and components thereof that may be suitable for separation and/or purification of biomolecules as disclosed herein are provided in U.S. Pat. Nos. 5,788,826, 7,344,629, 7,780,833, 7,959,780, 8,293,085, and U.S. Patent Application Nos. 2006/0138997, 2007/0108056, and 2007/0175766, which are incorporated by reference herein in their entireties. Other configurations and materials that are suitable for the electrochemical cell are contemplated within the scope of the methods and systems disclosed herein and will be apparent to those of skill in the art.

### Water-Splitting Ion Exchange Membrane

An electrochemical cell as described herein includes one or more (e.g., one or a plurality of) bipolar ion exchange membrane(s), such as ion exchange membrane(s) capable of water splitting. A bipolar ion exchange membrane (e.g., water-splitting membrane) herein includes a cation-exchange surface (e.g., a cation-exchange layer) that includes a cation-exchange material (e.g., acidic cation-exchange group(s)) and an anion-exchange surface (e.g., an anion-exchange layer) that includes an anion-exchange material (e.g., anion-exchange group(s)). In some embodiments, a bipolar ion exchange membrane (e.g., water-splitting membrane) herein includes a cation-exchange surface and an anion-exchange surface on opposing sides of the membrane, for example, abutting cation and anion exchange surfaces on opposing sides of the membrane. In some embodiments, the cation exchange layer is constructed with a strong acid resin in combination with an anion layer constructed with a weak or strong base resin. In some embodiments, the cation exchange layer is constructed with a weak acid resin in combination with an anion layer constructed with a weak or strong base resin.

A water-splitting membrane herein may be any structure that includes a cation-exchange surface and an anion-exchange surface in combination such that under a sufficiently high electric field, e.g., produced by application of a voltage to two electrodes, water is dissociated into its component ions H⁺ and OH⁻ in the membrane. Hydronium ions (H₃O⁺ may also be created, e.g., during a process of self-ionization. Although not wishing to be bound by theory, the dissociation of water may occur most efficiently at the boundary between the cation and anion exchange surfaces in the membrane, or in the volume between them. The resulting H⁺ and OH⁻ ions may migrate through an ion exchange layer in the direction of the electrode having an opposite polarity. For example, H⁺ will migrate toward the negative electrode (cathode) and OH⁻ will migrate toward the positive electrode (anode).

In some embodiments, a water-splitting membrane herein contains abutting cation and anion exchange surfaces. For example, cation and anion exchange layers may be secured or bonded to each other to provide a water-splitting membrane with a unitary laminate structure. The cation and anion exchange layers may be in physical contact without a bond securing them together, or the water-splitting membrane may include a non-ionic middle layer, such as, but not limited to, a water-swollen polymer layer, a porous layer, or a solution-containing layer.

A cation-exchange surface in a water-splitting membrane herein may include one or more acidic functional groups capable of exchanging cations. Nonlimiting examples of such acidic functional groups include —COOM, —SO₃M, —PO₃M, and C₆H₄OM, where M is a cation (e.g., hydrogen, sodium calcium or copper ion). Cation exchange materials may also include neutral groups or ligands that bind cations through coordinate rather than electrostatic or ionic bonds, including but not limited to, pyridine, phosphine, or sulfide groups. Other groups suitable for use in a cation exchange material include those that include complexing or chelating moieties, including but not limited to, those derived from aminophosphoric acid, aminocarboyxlic acid, or hydroxamic acid. As described in Example 4, a metal ion (e.g., Fe³⁺) may be exchanged for the cation exchange material on the membrane prior to exposure to a solution containing a metal binding molecule (such as but not limited to lactoferrin which is an iron binding molecule).

An anion-exchange surface in a water-splitting membrane herein may include one or more basic functional groups capable of exchanging anions. Nonlimiting examples of such basic functional groups include —NR₃A, —NR₂HA, —PR₃A, —SR₂A, and —C₅H₅NHA (pyridinium), where R is an alkyl, aryl, or other organic group and A is an anion (e.g., hydroxide, bicarbonate, chloride, or sulfate ion).

In some embodiments, a water-splitting membrane herein may contain a textured surface (e.g., at least a portion of the cation and/or anion exchange surface(s)) with spaced apart peaks and valleys.

Nonlimiting examples of water-splitting membranes and configurations thereof that may be suitable for separation and/or purification of biomolecules as disclosed herein are provided in U.S. Pat. Nos. 5,788,826, 7,344,629, 7,780,833, 7,959,780, 8,293,085, and U.S. Patent Application Nos. 2006/0138997, 2007/0108056, and 2007/0175766, which are incorporated by reference herein in their entireties. Other configurations and materials that are suitable for the water-splitting membranes are contemplated within the scope of the methods and systems disclosed herein and will be apparent to those of skill in the art.

In some embodiments, a water-splitting membrane may be prepared using any method, to construct heterogeneous and homogenous membranes. For example, homogeneous membranes include polymerized monomers to which ion exchange groups are added chemically, e.g., to ensure the charged groups are uniformly distributed through the membrane. An example of a homogeneous membrane is cross-linked polystyrene that has been either sulfonated, using sulphuric acid (cation), or formation of quaternary amines using trimethylamine (anion). Heterogeneous membranes may be constructed, for example, using finely powdered cation or anion monomer exchange particles, e.g., uniformly dispersed in a polymer such as, for example, polyethylene or polypropylene. In some embodiments, heterogeneous membranes may be more stable, due to structural support provided by the polymers.

In some embodiments, a water-splitting membrane can include more than one cation exchange and/or more than one anion exchange layer, and the ion exchange functional groups and/or ion exchange capacities of each respective layer can be the same or different. For example one cation exchange layer may contain a strong acid (e.g., derived from a sulfonic acid group (HSO₃⁻, which is ionizable over a broad pH range, and hence has a large ion exchange capacity), and the secondary cation exchange layer may contain a weak acid (e.g., derived from a carboxylic group (—COOH), which is ionizable over a much narrower pH range and hence has a lower ion exchange capacity). In another example, one anion exchange layer may contain a strong base (e.g., derived from a quaternary ammonium group which is ionizable over a broad pH range, and hence has a large ion exchange capacity), and the secondary anion exchange layer may contain a weak base (e.g., derived from a primary (R—NH₂), secondary (R—NHR′), or tertiary (R—NR′2) amine group, which is ionizable over a much narrower pH range, and hence has a lower ion exchange capacity).

### Biomolecules

Using the methods and systems described herein, one or more biomolecule(s) may be separated or purified from a solution. For example, in an electrochemical cell as described herein, both positively-charged biomolecules and negatively-charged biomolecules in a solution or buffer (e.g., an aqueous biomolecule-containing solution, for example, at any pH (e.g., 1.0-14.0)) that flows through the electrochemical cell and in contact with a water-splitting ion exchange membrane that contains both anion exchange and cation exchange surfaces may be separated from other components of the solution. The charged biomolecules bind to the water-splitting membrane when a voltage is applied and may be recovered from the membrane by reversing the polarity of the electrodes as described herein. Neutrally-charged biomolecules may also be separated or purified from a solution in the flow through.

In some embodiments, positively-charged biomolecules bind to a cation exchange surface of a water-splitting ion exchange membrane and are separated or purified from a solution. In some embodiments, negatively-charged biomolecules bind to an anion exchange surface of a water-splitting ion exchange membrane and are separated or purified from a solution. In some embodiments, both positively-charged and negatively-charged biomolecules bind to cation exchange and anion exchange surfaces, respectively, and are simultaneously separated or purified from a solution. In some embodiments, neutrally-charged biomolecules are recovered or purified from a solution in the flow through. Any charged or neutral biomolecule that binds to a water-splitting ion exchange membrane under a voltage or that does not bind and flows through an electrochemical cell as described herein may be separated or purified from a solution.

In some embodiments, biomolecules that bind to and are released from the water-splitting membrane are concentrated in comparison to the biomolecule-containing solution from which they originated.

Examples of biomolecules that may be separated or purified from a solution according to a method as disclosed herein include, but are not limited to, proteins, peptides, amino acids, nucleic acids, oligonucleotides, nucleotides, lipids, fatty acids, carbohydrate molecules (e.g., mono-, di-, and polysaccharides), glycolipids, vitamins, metabolites, co-factors, and hormones.

Examples of biomolecule-containing solutions that may be introduced into an electrochemical cell in a method as described herein include, but are not limited to, cell extracts, plant extracts, body fluids, biomolecule synthesis mixtures, fermentation broth (e.g., microbial growth medium that contains one or more microbially-produced bioproduct(s), including but not limited to a biomolecule, such as, but not limited to, a recombinant polypeptide), and food, beverage, or beverage-derived liquids (including but not limited to milk and whey). In some embodiments, the solution may be diluted or concentrated prior to introduction into the electrochemical cell, in view of the capacity of the membrane(s), flow rate of the solution, or other operating parameters.

For example, a biomolecule-containing solution may contain a plurality of positively-charged and negatively-charged proteins. In some embodiments, both positively-charged and negatively-charged proteins are simultaneously separated from the solution in a method as described herein. In some embodiments, both positively-charged and negatively-charged proteins are simultaneously separated from the solution in native (e.g., non-denatured) configurations. In some embodiments, recovered proteins retain their inherent biological activity. For example, recovered enzymes retain enzymatic activity.

In another example, a biomolecule-containing solution may contain a plurality of positively-charged and negatively-charged proteins, and uncharged lipid and/or carbohydrate molecules. A nonlimiting example of such a solution is whey, which contains positively-charged proteins (e.g., lactoferrin, lactoperoxidases, and immunoglobulins), negatively-charged proteins (e.g., bovine serum albumin (BSA), beta-lactoglobulin, and alpha-lactalbumin), lactose minerals and fats. The positively-charged and negatively-charged proteins may bind to the water-splitting membrane and the uncharged lipid and/or carbohydrate molecules (e.g., lactose in whey) may be recovered in the flow through. The positively-charged and negatively-charged proteins may be recovered when the system is regenerated by reversing the polarity of the electrodes. In some embodiments, positively- and negatively-charged proteins are recovered from whey via regeneration of the water-splitting ion exchange membrane as disclosed herein in their native, biologically active configurations. In some embodiments, positively- and negatively-charged proteins are recovered from whey via regeneration of the water-splitting ion exchange membrane as disclosed herein at higher concentrations than in the whey solution that was introduced into the electrochemical cell.

In some embodiments, one or more biomolecule(s) to be separated and/or purified according to a method described herein contain a tag, for example, to further assist in purification, visualization, and/or quantitation of the biomolecule(s). Nonlimiting examples of tags include a his tag, a glutathione-S-transferase (GST) tag, a flurorescent tag, a green fluorescent protein (GFP) tag, or an maltose-binding protein (MBP) tag. In one embodiment, one or more biomolecule(s) contains a cationic or anionic tag that is positively or negatively charged, respectively, in the solution that contains the biomolecule(s). A cationic or anionic tag may bind to the cation or anion exchange surface, respectively, of the water-splitting ion exchange membrane as the solution containing the biomolecule(s) flows through the electrochemical cell. In one embodiment, the tag includes a cationic polyhistidine sequence (i.e., a “his tag”). In one embodiment, the biomolecule is a protein that includes one or more tag(s). In one embodiment, the biomolecule is a protein that includes one or more his tag(s).

In one embodiment, one or more biomolecule(s) to be separated and/or purified according to a method described herein has a strong binding affinity for a specific ion, to further assist in purification, visualization, and/or quantitation of the biomolecule(s). A nonlimiting example includes purification of lactoferrin which has a strong affinity for binding Fe³⁺ ions as described in Example 4. As an example, Fe³⁺ ions may be introduced/exchanged on the cation exchange surface of the water-splitting ion exchange membrane prior to the solution containing the biomolecule(s) of interest entering the electrochemical cell, to assist in binding of the specific iron binding protein (e.g., lactoferrin).

### Demineralization

Using the methods and systems described herein, one or more ion(s) may be separated from a solution that contains one or more biomolecule(s) and one or more ion(s). The solution may be an aqueous solution or buffer that contains one or more biomolecule(s) and one or more ion(s), for example, a solution or buffer at pH 1.0-14.0. For example, in an electrochemical cell as described herein, both positively-charged ions and negatively-charged ions in a solution that contains one or more biomolecule(s) and one or more ion(s) (e.g., an aqueous biomolecule-containing solution such as whey at any given pH, for example, pH 1.0-14.0) that flows through the electrochemical cell and is in contact with a water-splitting ion exchange membrane that contains both anion exchange and cation exchange surfaces may be separated from other components of the solution. The charged ions bind to the water-splitting membrane when a voltage is applied and may be recovered from the membrane by reversing the polarity of the electrodes as described herein. In some embodiments, a portion of the charged biomolecules also bind to the membrane and are recovered along with the bound ions by reversing the polarity of the electrodes. In other embodiments, all or substantially all of the charged biomolecules flow through the electrochemical cell, along with neutrally charged molecules. In some embodiments, neutrally-charged biomolecules, such as but not limited to, lactose, may be separated or purified from the flow through (demineralized).

Methods are provided for demineralizing a solution that contains one or more biomolecule(s) and ion(s). The methods disclosed herein include contacting an ion exchange membrane (e.g., an ion exchange membrane capable of water splitting, such as a bipolar membrane) with a solution to be demineralized (a solution that contains at least one biomolecule and at least one ion), under a voltage sufficient to effect exchange of cationic ions with a cation on a cation-exchange surface of the membrane and/or exchange of anionic ions with an anion on an anion-exchange surface of the membrane. In some embodiments, cationic and/or anionic ions bind to the cationic or anionic surface of the membrane, respectively, as the solution containing at least one biomolecule and at least one ion (e.g., in nonlimiting examples, whey, UFR, UFP or deproteinized whey), flows through an electrochemical cell that contains at least one water-splitting ion exchange membrane and electrodes, under a voltage sufficient for the binding to occur, thereby producing a demineralized solution which flows through the electrochemical cell. The demineralized solution may contain charged and uncharged biomolecules. The ions may be extracted or expelled from the membrane by reversing the polarity of the electrodes (“regeneration”).

In some embodiments, positively-charged ions bind to a cation exchange surface of a water-splitting ion exchange membrane and are separated or purified from a solution. In some embodiments, negatively-charged ions bind to an anion exchange surface of a water-splitting ion exchange membrane and are separated or purified from a solution. In some embodiments, both positively-charged and negatively-charged ions bind to cation exchange and anion exchange surfaces, respectively, and are simultaneously separated or purified from a solution. In some embodiments, the solution also contains both charged biomolecules and neutrally-charged biomolecules which are recovered in the flow through, considered to be “demineralized”. Any charged or neutral biomolecule or ion that binds to a water-splitting ion exchange membrane under a voltage or that does not bind and flows through an electrochemical cell as described herein may be separated or purified from the flow through solution.

In methods described herein, cationic and anionic ions may be recovered together from a starting solution that contains both cationic and anionic ions.

In some embodiments, ions that bind to and are released from the water-splitting membrane are concentrated in comparison to the biomolecule-containing solution (e.g., biological solution) from which they originated.

In some embodiments, over 80% of the ions present in the original biomolecule and ion-containing solution are bound and separated from the flow through or demineralized solution, regardless of charge (positive or negative) or valence (monovalent or multivalent).

In some examples of the methods herein, the solution that contains one or more biomolecule(s) and one or more ion(s) for demineralization, can be at any pH (e.g., 1.0-14.0).

In some examples of the methods herein, the solution used to expel the one or more ions from the water-splitting membrane during demineralization can be at any pH (e.g., 1.0-14.0).

Examples of ions that may be separated or purified from a solution that contains one or more biomolecule(s) and one or more ion(s) according to a method as disclosed herein include, but are not limited to, Calcium (e.g., Ca²⁺), Magnesium (e.g., Mg²⁺), Phosphate (e.g., PO₄²⁻) Potassium (e.g., K⁺), Chloride (e.g., Cl⁻), Sodium (e.g., Na⁺), Zinc (e.g., Zn²⁺), Iron (e.g., Fe²⁺, Fe³⁺), Iodine (e.g., I⁻), Copper (e.g., Cu²⁺, Cu³⁺), and Sulfate (SO₄²⁻).

Examples of solutions that contain one or more biomolecule(s) and one or more ion(s) that may be introduced into an electrochemical cell in a method as described herein include, but are not limited to, cell extracts, plant extracts, body fluids, biomolecule synthesis mixtures, fermentation broth (e.g., microbial growth medium that contains one or more microbially-produced bioproduct(s), including but not limited to a biomolecule, such as, but not limited to, a recombinant polypeptide), and food, beverage, or beverage-derived liquids (including but not limited to milk and whey). In some embodiments, the solution that contains one or more biomolecule(s) and one or more ion(s) may be diluted or concentrated prior to introduction into the electrochemical cell, in view of the capacity of the membrane(s), flow rate of the solution, or other operating parameters.

For example, a solution that contains one or more biomolecule(s) and one or more ion(s) may contain a plurality of positively-charged and negatively-charged ions. In some embodiments, both positively-charged and negatively-charged ions are separated from the solution in a method as described herein. In some embodiments, both positively-charged and negatively-charged ions are bound and simultaneously separated from the solution while remaining biomolecules such as proteins and lactose remain in their native (e.g., non-denatured and biologically active) configurations in the flow through as a demineralized solution.

In another example, a solution that contains one or more biomolecules and one or more ion(s) may contain a plurality of positively-charged and negatively-charged proteins, and uncharged lipid and/or carbohydrate molecules as well as charged ions. A nonlimiting example of such a solution is whey, which contains positively-charged proteins (e.g., lactoferrin, lactoperoxidases, and immunoglobulins), negatively-charged proteins (e.g., bovine serum albumin (BSA), beta-lactoglobulin, and alpha-lactalbumin), uncharged carbohydrates (e.g., lactose) and milk fats, as well as charged ions (e.g., milk minerals).

By controlling variables such as pH, the flow rate, membrane composition (cation and/or anion resins used for extrusion of the water-splitting membrane) and other operating parameters of the system, the positively-charged and negatively-charged ions preferentially bind to the water-splitting membrane and the uncharged lipid and/or carbohydrate molecules (e.g., lactose in whey) as well as a significant portion of the proteins (regardless of charge), may be recovered in the flow through as demineralized whey. If ions are present in a biomolecule-containing solution, they may have a competitive advantage to preferentially bind to the membrane due to their strong ionic binding or electrostatic attraction to the membrane, compared to the binding strength of the remaining charged biomolecules in solution (e.g., proteins). This competitive ionic binding may lead to displacement of any bound proteins in preference for smaller and highly charged ions present in the solution. Once the ions are bound and removed, other charged molecules remaining in the demineralized solution can subsequently bind to the membrane without ionic competition and may be extracted or purified from uncharged biomolecules in the demineralized solution. The positively-charged and negatively-charged ions may be recovered when the system is regenerated. In some embodiments, positively- and negatively-charged ions are recovered from whey as milk minerals via regeneration of the water-splitting ion exchange membrane as disclosed herein as milk minerals. In some embodiments, positively- and negatively-charged ions are recovered from whey via regeneration of the water-splitting ion exchange membrane as disclosed herein at higher concentrations than in the whey solution that was introduced into the electrochemical cell.

In one embodiment, the solution that contains one or more biomolecule(s) and one or more ion(s) is whey (or a derivative of whey such as but not limited to deproteinized whey/UFP or UFR), which may contain cationic and anionic polypeptides, and/or uncharged carbohydrates (e.g., lactose), and/or lipids and/or other micronutrients including milk minerals (e.g., ions). At least a portion of the charged cationic and anionic ions bind to the cationic and anionic surfaces, respectively, of the water-splitting ion exchange membrane(s), and at least a portion of proteins, and/or uncharged carbohydrates (e.g., lactose) and/or lipids exit the electrochemical cell in the flow through as a demineralized solution. Both cationic and anionic, monovalent and multivalent ions may be recovered together from whey (or a derivative of whey such as but not limited to deproteinized whey/UFP or UFR), and separated from protein, and/or lactose and/or lipids, which exit in the flow through as a demineralized solution. In some embodiments, one or more ion(s) in whey or deproteinized whey is recovered at a higher concentration than the whey solution from which it was derived.

In one embodiment, the composition of a solution containing one or more biomolecule(s) and one or more ion(s) for the process of demineralization includes a food and/or beverage liquid such as a milk-derived solution (e.g., whey and whey derivatives including but not limited to, UFR and deproteinized whey/UFP). Ion(s) separated and removed from whey and its derivatives may include, but are not limited to Calcium (e.g., Ca²⁺), Magnesium (e.g., Mg²⁺), Phosphate (e.g., PO₄²⁻) Potassium (e.g., K⁺), Chloride (e.g., Cl⁻), Sodium (e.g., Na⁺), Zinc (e.g., Zn²⁺), Iron (e.g., Fe²⁺, Fe³⁺), Iodine (e.g., I⁻), Copper (e.g., Cu²⁺, Cu³⁺), and Sulfate (SO₄²⁻).

In one embodiment, the composition of a solution containing one or more biomolecule(s) and one or more ion(s) for the process of demineralization includes a biomolecule-containing solution which has been previously treated ((including but not limited to ultra/nano filtration e.g., deproteinized whey/UFP or UFR). The composition may include, for example, one or more polypeptide(s), and/or one or more carbohydrate(s), and/or one or more lipid(s), and/or one or more ion.

### Methods for Separation of Biomolecules

Methods are provided for separating and/or purifying biomolecules from a solution. The solution may contain ions, or may be demineralized prior to separation of biomolecules.

In some embodiments, a solution that contains one or more biomolecule(s) and one or more ion(s) is demineralized in a first process (e.g., a first pass through an electrochemical cell as described herein), and then charged biomolecules, such as cationic and anionic polypeptides (e.g., charged biomolecules in the flow through of the first pass through the electrochemical cell), are separated from the demineralized solution (e.g., flow through from the first pass through the electrochemical cell) in a second process (e.g., a second pass through an electrochemical cell as described herein).

In some embodiments, a specific cationic or anionic biomolecule (e.g., a polypeptide) is bound and purified from a solution using the methods and systems described herein. In some embodiments, the specific biomolecule (e.g., a polypeptide) is recovered at a higher concentration than the starting solution from which it was derived. In some embodiments, the specific biomolecule (e.g., a polypeptide) is recovered in its native (e.g., non-denatured and/or biologically active) configuration.

The methods disclosed herein include contacting an ion exchange membrane (e.g., an ion exchange membrane capable of water splitting, such as a bipolar membrane) with a solution that contains at least one biomolecule to be separated and/or purified, under a voltage sufficient to effect exchange of cationic biomolecules with a cation on a cation-exchange surface of the membrane and/or exchange of anionic biomolecules with an anion on an anion-exchange surface of the membrane. In some embodiments, cationic and/or anionic biomolecules bind to the cationic or anionic surface of the membrane, respectively, as the biomolecule-containing solution flows through an electrochemical cell that contains at least one water-splitting ion exchange membrane and electrodes, under a voltage sufficient for the binding to occur. The biomolecules may be extracted from the membrane by reversing the polarity of the electrodes (“regeneration”).

In one embodiment, the method includes applying a voltage to an electrochemical cell that contains: (a) a housing with at least one inlet and at least one outlet; (b) first and second electrodes; (c) at least one water-splitting membrane between the first and second electrodes and including: (i) a cation exchange surface facing the first electrode and containing a bound cation, and (ii) an anion exchange surface facing the second electrode and containing a bound anion; and (d) a biomolecule-containing solution. In some embodiments, the biomolecule-containing solution contains one or more biomolecule(s) and one or more ion(s). In some embodiments, the biomolecule-containing solution is a demineralized solution. The solution flows through a continuous channel from an inlet to an outlet of the cell and contacts the cation and/or anion exchange surfaces of the membrane. In some embodiments, biomolecule(s) in the solution bind to the cation exchange surface or the anion exchange surface or exit the electrochemical cell through an outlet as an unbound molecule.

Bound biomolecules may be recovered in a regeneration process that includes reversing the polarity of the first and second electrodes and flowing a solution (e.g., water or an aqueous or other suitable solution in which the biomolecules are soluble (e.g., at any pH (e.g. 1.0-14.0)) through the electrochemical cell. The bound cationic and/or anionic biomolecules are displaced by H⁺ or OH⁻ that is produced in the water-splitting reaction, and the biomolecules then exit with the solution through an outlet in the electrochemical cell.

In methods described herein, cationic and anionic biomolecules may be recovered simultaneously from a starting solution that contains both cationic and anionic biomolecules. In some embodiments, biomolecules are recovered at a higher concentration than the starting solution from which they were derived. In some embodiments, biomolecules such as polypeptides are recovered in their native (e.g., non-denatured and/or biologically active) configuration.

In various embodiments, charged biomolecules that bind to the cation exchange and/or anion exchange surface(s) of the water-splitting ion exchange membrane(s) are selected from polypeptides and polynucleotides, carbohydrates (e.g., monosaccharides, disaccharides, and/or polysaccharides) and lipids. In various embodiments, uncharged biomolecules that exit the electrochemical cell in the flow through are selected from polypeptides, polynucleotides, monosaccharides, polysaccharides, and lipids. In one embodiment, charged polypeptides bind to the cation exchange and/or anion exchange surface(s) of the water-splitting ion exchange membrane(s), and uncharged carbohydrate molecules, lipids and other micronutrients exit the electrochemical cell in the flow through.

In one embodiment, the biomolecule-containing solution is whey (or a derivative of whey such as, but not limited to, demineralized whey or UFR), which contains cationic and anionic polypeptides, uncharged carbohydrates (e.g., lactose), lipids and other micronutrients. In some embodiments, whey (or a derivative of whey such as, but not limited to ultrafiltration retentate or permeate) is demineralized in a first process (e.g., a first pass through an electrochemical cell as described herein), after which, the remaining charged biomolecules, such as cationic and anionic polypeptides (e.g., charged biomolecules in the flow through of the first pass through the electrochemical cell), are separated from the demineralized whey (e.g., flow through from the first pass through the electrochemical cell) in a second process (e.g., a second pass through an electrochemical cell as described herein). At least a portion of the charged cationic and anionic polypeptides bind to the cationic and anionic surfaces, respectively, of the water-splitting ion exchange membrane(s), and at least a portion of uncharged carbohydrates (e.g., lactose) and lipids exit the electrochemical cell in the flow through. The cationic polypeptides may include, but are not limited to, lactoferrin, lactoperoxidases, and/or immunoglobulins. The anionic polypeptides may include, but are not limited to, bovine serum albumin, beta lactoglobulin, alpha lactalbumin, and/or glycomacropeptide. Both cationic and anionic polypeptides may be recovered together from whey (or a derivative of whey such as, but not limited to, demineralized whey or UFR), and separated from lactose and lipids, which exit in the flow through. In some embodiments, one or more polypeptide(s) in whey is recovered at a higher concentration than the whey solution from which it was derived. In some embodiments, one or more polypeptide(s) is recovered from whey in its native conformation and possessing at least a portion of its original biological activity.

In one embodiment, the biomolecule-containing solution is whey (or a derivative of whey such as, but not limited to, demineralized whey or UFR), from which a specific cationic or anionic polypeptide is separated by exploiting an inherent binding capability of the biomolecule. In one embodiment, the specific polypeptide is lactoferrin which binds to the cation exchange layer of the water-splitting membrane due to its strong binding affinity for Fe³⁺ ions as described in Example 4.

### Systems

Systems are provided for practice of the methods described herein. For example, a system for separating or purifying one or more biomolecule(s) from a biomolecule-containing solution may include an electrochemical cell and other equipment required for the operation of the cell, including, but not limited to, equipment for providing a voltage to the electrodes, such as a power supply; equipment for introducing and/or regulating flow of a solution through the cell, such as a pump; container(s) to house incoming solution; sensor(s) to measure output, adjust incoming flow rate, regulate voltage, etc.; and/or equipment for collecting solution that exits the cell through the outlet(s). A system herein may contain a biomolecule-containing fluid within the electrochemical cell and in contact with at least one surface (e.g., cation exchange and/or anion exchange surface(s)) of at least one water-splitting ion exchange membrane.

Systems that contain two or more electrochemical cells, of any scale in fluid communication with one another and capable of concurrent operation are also provided. Two or more electrochemical cells of any scale may be connected in fluid communication in parallel and/or in series for concurrent operation within a system. In some embodiments, one or more cells, of any scale, may operate in production mode and one or more cells may operate in regeneration mode, simultaneously within the same system, with the cells in fluid communication and connected in parallel and/or in series within the system.

### Compositions

Compositions are provided that include one or more biomolecule(s) separated or purified from a solution, according to methods as described herein. Also provided are solutions from which one or more biomolecule(s) have been removed, according to a method as described herein.

Compositions are also provided that include one or more ion(s) separated or purified from a solution containing one or more biomolecule(s) and one or more ion(s) according to methods as described herein. Also provided are solutions from which one or more ion(s) have been removed, according to methods as described herein.

In some embodiments, the composition includes one or more biomolecule(s) and/or ion(s) that have been separated or purified from a cell extract, plant extract, bodily fluid, biomolecule synthesis mixture, fermentation broth, or food/beverage-derived liquids (including but not limited to milk and whey) or the like, as described herein. The composition may include, for example, but not limited to, one or more polypeptide(s), one or more carbohydrate(s), one or more lipid(s), and/or one or more polynucleotide(s), and may optionally further include one or more ion(s). In some embodiments, the composition may be a solution in which one or more biomolecule(s) and/or ion(s) are more concentrated than in the solution from which they were derived. In some embodiments, one or more biomolecule(s) in the composition is (are) in a native (e.g., biologically active) conformation. In some embodiments, the solution in which one or more biomolecule(s) and/or ion(s) are present, passes through the electrochemical cell from one outlet to the other without fouling the membrane which is capable of water-splitting. In some embodiments, at least a portion of the liquid may be removed from a solution that contains the separated or purified biomolecule(s) (e.g., by drying (e.g., spray drying), lyophilization, or the like).

In some embodiments, the composition includes one specific biomolecule that has been separated or purified from a cell extract, plant extract, bodily fluid, biomolecule synthesis mixture, fermentation broth, or food/beverage-derived liquids (including but not limited to milk and whey) or the like, as described herein. The composition may include, for example, but not limited to, a polypeptide such as lactoferrin as described in Example 4. In some embodiments, the bound and recovered specific polypeptide may be more concentrated than in the solution from which it was derived. In some embodiments, the polypeptide is in a native (e.g., biologically active) conformation. In some embodiments, at least a portion of the liquid may be removed from a solution that contains the separated or purified polypeptide (e.g., by drying (e.g., spray drying), lyophilization, or the like).

In some embodiments, the composition includes one or more biomolecule(s) that have been recovered in the flow through (e.g., biomolecule(s) that did not bind to the water-splitting ion exchange membrane) in a method as described herein. The composition may include, for example, but not limited to, one or more polypeptide(s), and/or one or more carbohydrate(s), and/or one or more lipid(s), and/or one or more polynucleotide(s). In some embodiments, one or more biomolecule(s) in the composition is (are) in a native (e.g., biologically active) conformation. In some embodiments, at least a portion of the liquid may be removed from a solution that contains the biomolecule(s) recovered in the flow through (e.g., by drying (e.g., spray) drying, lyophilization, or the like).

In some embodiments, the composition is a solution (e.g., a cell extract, plant extract, bodily fluid, biomolecule synthesis mixture, fermentation broth, or food/beverage-derived liquids (including but not limited to milk and whey) etc.) from which at least a portion of one or more biomolecule(s) and/or ion(s) have been removed by passage through an electrochemical cell, in a method as described herein. For example, the composition may be a solution from which, for example, but not limited to, one or more polypeptide(s), and/or one or more carbohydrate(s), and/or one or more lipid(s), and/or one or more polynucleotide(s) have been removed.

In one embodiment, the composition includes one or more polypeptide(s) separated from a milk solution (e.g., whey and whey derivatives including, but not limited to, demineralized whey, or ultrafiltered retentate (UFR)). Polypeptide(s) separated from whey or derivatives of whey may include, but are not limited to, lactoferrin, lactoperoxidases, immunoglobulins, bovine serum albumin, beta lactoglobulin, alpha lactalbumin, and/or glycomacropeptide. In some embodiments, one or more of the polypeptide(s) is more concentrated than in the solution (e.g., whey or a derivative of whey such as but not limited to demineralized whey, or UFR),) from which they were derived. In some embodiments, one or more of the polypeptide(s) is in a native (e.g., biologically active) conformation.

In some embodiments, the composition includes one or more ion(s) that have been separated or removed from a solution that contains one or more biomolecule(s) and one or more ion(s), including, but not limited to, food and/or beverage-derived liquids (including but not limited to milk and whey) as described herein. The composition may include, for example, but not limited to, at least some portion of ion(s), and/or at least some portion of one or more polypeptide(s), and/or at least some portion of carbohydrate(s), and/or at least some portion of lipid(s). In some embodiments, the composition may be a solution in which one or more ions(s) are more concentrated than in the solution from which they were derived. In some embodiments, one or more ions(s) in the composition is (are) in their natural form and ratios (e.g., ions present in whey, known as milk minerals). In some embodiments, at least a portion of the liquid may be removed from a solution that contains the separated or removed ion(s) (e.g., by heat and evaporation, drying (e.g., spray drying), lyophilization, or the like).

In some embodiments, the composition includes one or more biomolecule(s) that have been recovered in the flow through as a demineralized solution (e.g., biomolecule(s) that did not bind to the water-splitting ion exchange membrane) in a method as described herein. The composition may include, for example, but not limited to, one or more polypeptide(s), and/or one or more carbohydrate(s), and/or one or more lipid(s), and/or one or more polynucleotide(s). In some embodiments, one or more biomolecule(s) recovered in the flow through as a demineralized solution, in the composition is (are) in a native (e.g., biologically active) conformation. In some embodiments, at least a portion of the liquid may be removed from a solution that contains the biomolecule(s) recovered in the flow through as a demineralized solution (e.g., by drying (e.g., spray) drying, lyophilization, or the like).

In some embodiments, the composition is a solution (e.g., a cell extract, plant extract, bodily fluid, biomolecule synthesis mixture, fermentation broth, or food/beverage-derived liquids (including but not limited to milk and whey) etc.) from which at least a portion of one or more ions(s) have been removed (or demineralized) by passage through an electrochemical cell, in a method as described herein.

In one embodiment, the composition is a food and/or beverage solution, for example, a milk solution (e.g., whey and whey derivatives including but not limited to, demineralized whey, UFR and deproteinized whey/UFP) from which at least a portion of one or more polypeptide(s) have been separated by passage through an electrochemical cell, in a method as described herein. In an embodiment, whey polypeptide(s), at least a portion of which may have been purified, include, but are not limited to, lactoferrin, lactoperoxidases, immunoglobulins, bovine serum albumin, beta lactoglobulin, alpha lactalbumin, and/or glycomacropeptide. In some embodiments, the composition from which at least a portion of one or more polypeptide(s) have been separated, includes carbohydrate(s) (e.g., lactose) and/or lipid(s).

In one embodiment the composition of a solution containing one or more biomolecule(s) and one or more ion(s) comprises, consists of, or consists essentially of whey that has previously been treated by a prior method, including but not limited to microfiltration, ultrafiltration, nanofiltration, reverse osmosis, electrodialysis, ion exchange or diafiltration.

In one embodiment, the composition of a product is lactose or deproteinized whey powder comprising >80% lactose or deproteinized whey that has been separated from the milk minerals of whey (demineralized).

In one embodiment, the composition of a product is a milk mineral powder comprising cationic and anionic milk minerals separated from other components in whey (or derivatives of whey such as but not limited to, deproteinized whey).

In one embodiment, the composition of a product is a demineralized whey (or a demineralized derivative of whey such as, but not limited to, ultrafiltration retentate or permeate) powder comprising cationic and/or anionic polypeptides, and/or lactose/and/or fat that have been separated from milk minerals of whey.

In one embodiment, the composition of a product is a protein powder comprising cationic and/or anionic polypeptides of whey, which have been separated from milk minerals and/or fat and/or lactose.

In one embodiment, the composition of a product is a specific protein powder comprising a cationic or anionic polypeptide of whey, which has been separated from other components in whey due to targeted specific binding, for example, as described in Example 4.

The following examples are intended to illustrate, but not limit, the invention.

### EXAMPLES

Example 1

### Procedure

An experiment was performed to determine the recovery and reproducibility of using an electrochemical system with a bipolar water-splitting ion exchange membrane for demineralization of whey and whey derivatives (e.g., UFP and UFR). A commercially available LINX® 140T TDS Cartridge system, available from Pionetics Corp., was used. This system includes two cartridges, each with a spiral bound textured bipolar sheet that contains a cation exchange layer abutting an anion exchange layer.

Pasteurized liquid whey was obtained from Petaluma Creamery, as was the ultrafiltration retentate (or UFR, containing concentrated protein, fat, ions and at least a portion of lactose after processing through an ultrafiltration system). The ultrafiltration permeate (or UFP, containing fat, ions, concentrated lactose and at least a portion of the whey proteins after processing through an ultrafiltration system), was also processed as “deproteinized” whey.

Samples of whey, UF retentate (concentrated whey protein and ions) and UF permeate (deproteinized whey/concentrated lactose and ions) were passaged through the LINX® 140T TDS Cartridge system with an electric current applied (voltage set at 300V). The operating parameters were 100-120 Vac, 50/60 Hz, 6 A, and flow rate >0.5 L/min. All samples were diluted with distilled water prior to use, at a dilution factor of approximately 1:5 (sample: water), to lower the conductivity of the solutions to approximately 2000 μS/cm (to stay within the operating range of the current scale of the LINX® 140T TDS Cartridge system. Approximately 10 L of each dilute sample (whey, UF retentate and UF permeate respectively) were passaged through LINX® 140T TDS Cartridge system under an electric current, separating at least a portion of ions that bound to the water-splitting membrane, from the other components in the solutions (biomolecules), that did not bind to the water-splitting membrane and flowed through the cartridge as a demineralized solution. Bound ions from each sample were recovered by regenerating the membrane (reversing the polarity of the electrodes), using distilled water to produce a “regenerated” solution that contained the ions (milk minerals).

All solutions (diluted whey/UFR/UFP samples, deionized solutions and regenerated solutions), were analyzed for presence and quantity of ions, as measured by a digital conductivity meter (HM Digital COM-100 Waterproof Combo Meter for EC, TDS and Temperature).

Each dilute sample (whey, UF retentate or UF permeate) was treated in a continuous alternating process between the two cells of the LINX® 140T TDS Cartridge system. Each of the two cells treated the dilute sample volume (10 L) simultaneously during the “demineralization phase” after which, water (at pH 8.0) was used as the regeneration solution during the “regeneration phase”. Regeneration began with the first cell providing 2 L of “demineralized” water to the second cell as a solution for its regeneration process (i.e., the release of ions bound to the second cell). Next, the second cell, in turn, provided 2 L of “demineralized” water to the first cell as a solution for its regeneration process (i.e., the release bound ions bound to the first cell). After both cells regenerated, the “cycle” was complete and the system was then ready to treat the next sample.

Both the regenerated sample and the flow through sample collected from each experiment were analyzed quantitatively for either protein concentration or lactose concentration (depending on the source solution) as determined by spectrophotometry, and presence of ions as determined by a conductivity measurement.

### Quantitative Analysis

Protein concentration was determined using the Quick Start™ Bradford protein assay. The assay uses a dye reagent (Coomassie Brilliant Blue G-250), at 1×concentration. The dye exists in three forms; cationic (red), neutral (green) and anionic (blue). Under acidic conditions, the dye is predominantly in the doubly protonated red cationic form. However, when the dye binds to protein it is converted to a stable unprotonated blue form which is detected using a spectrophotometer at 595 nm. A standard curve was prepared using seven pre-diluted standards at the following concentrations (0.125, 0.25, 0.5, 0.75, 1.0, 1.5, and 2.0 mg/ml bovine serum albumin) and was used to calculate the concentration of protein in each of the samples.

Lactose content was determined using the EnzyChrom™ Lactose Assay Kit from Bioassays systems. This kit uses specific enzyme-coupled reactions in which lactose is cleaved into glucose and galactose molecules. The resulting galactose forms a colored product which can be read using a spectrophotometer at 570 nm. The color intensity is directly proportional to the lactose concentration in the sample.

Results are shown in Table 1.

Over 80% of the ions (milk minerals), regardless of charge, size or valence were bound and removed from each of the dilute feed streams (whey, UF retentate and UF permeate) (Table 1). The milk minerals (ions) which were bound to the membrane, were recovered during the regeneration step (by reversing the polarity of the electrodes), and efficiently removed from the feed streams producing demineralized whey, UF retentate or UF permeate respectively. The milk minerals (ions) that were bound to the membrane were recovered in water (without the use of any chemicals) during regeneration and hence could have been lyophilized or spray dried to produce natural milk minerals in their naturally occurring ratios. The resulting demineralized solutions from each of the samples still retained the majority of biomolecules originally present (proteins and/or lactose) which could have been further processed or separated using methods described herein.

Example 2

Procedure

An experiment was performed to determine the recovery and reproducibility of using an electrochemical system with a bipolar water-splitting ion exchange membrane for purification of biomolecules such as proteins from whey. A commercially available LINX® 140T Cartridge system, available from Pionetics Corp., was used. This system includes two cartridges, each with a spiral bound textured bipolar sheet that contains a cation exchange layer abutting an anion exchange layer.

Whey was produced by heating 4 gallons of 1% milk to about 65° C. Approximately ½ cup of dilute distilled vinegar was added per gallon of milk to separate the curd (coagulated casein protein) from the whey. The mixture was further separated by running the entire mixture through a fine cheesecloth. The whey was immediately cooled on ice until further processing.

Samples of dilute liquid whey were passaged through the LINX® 140T TDS Cartridge system with an electric current applied (voltage set at 300V). The operating parameters were 100-120 Vac, 50/60 Hz, 6 A, and flow rate <0.5 L/min. Whey was diluted with distilled water prior to use, at a dilution factor of approximately 1:15, to lower the conductivity of the whey solution to closely match the conductivity of hard, unfiltered tap water (approximately 1000 μS/cm). Dilution to lower the conductivity of the whey was performed to artificially represent a “demineralized” whey solution in which, protein binding would be favored over ion binding. Demineralization can be achieved by either removal of ions as described in Example 1 (or any other known demineralization method previously described) or dilution with water. Once whey is sufficiently demineralized, it can be further processed using methods described herein to extract and purify biomolecules such as proteins.

Two consecutive samples of dilute whey (approximately 21 L each) at a protein concentration of approximately 2.5 g/L (about 50 g total protein) were processed through the LINX® 140T TDS Cartridge system under sufficient electric current, to separate biomolecules that bound to the membrane (“bound biomolecules”) from those that did not bind and flowed through the cartridge (“flow through biomolecules”). Bound biomolecules were recovered by regenerating the system (reversing the polarity of the electrodes), with the same dilute whey as the original feed solution to produce a “regenerated” solution that contained the previously bound biomolecules (“recovered bound biomolecules,” such as “recovered bound protein”).

Each batch of dilute whey was processed in a continuous alternating process between the two cells of the LINX® 140T TDS Cartridge system. Each of the two cells processed the 21 L of dilute whey simultaneously during the “separation phase” after which, the cells entered “regeneration phase”. The first cell provided 2 L of “deproteinized flow through” material to the second cell as a solution for its regeneration process (i.e., to release biomolecules bound to the second cell). Subsequently, the second cell continued to provide 2 L of “deproteinized flow through” material to the first cell as a solution for its regeneration process (i.e., to release bound biomolecules bound to the first cell). After both cells regenerated, the “cycle” was complete and the system was then ready to treat the next batch. At the end of each cycle, approximately 6.5 L of regenerated solution was collected, which contained the concentrated bound biomolecules (proteins). Both samples containing the recovered bound biomolecules and the flow through biomolecules were analyzed quantitatively for protein concentration, qualitatively for protein content and size, and protein identification/biological state using polyacrylamide gel electrophoresis banding patterns.

### Quantitative Analysis

Protein concentration was determined by absorbance at 280 nm (A₂₈₀). Virtually all proteins exhibit a strong UV absorbance maximum near 280 nm. This characteristic absorbance is due almost entirely to the absorbance by the aromatic rings in the side chains of the amino acids tryptophan and tyrosine. The crude sample (undiluted whey) was diluted 1:100 due to the high initial concentration of whey. The regenerated and flow through samples were diluted 1:10. Sample dilutions were prepared in duplicate and A₂₈₀ readings were determined. The average protein concentration of each sample was calculated by multiplying the dilution factor by the average absorption value and then dividing by 1.4, which is the molar extinction coefficient of mammalian immunoglobulin. The results are shown in Table 2. About 5 times more concentrated protein was recovered in the regenerated stream than in the flow through.

TABLE 2

| | Volume | Average | Total | % |
|---|---|---|---|---|
| | of | Protein | protein | Yield |
| | sample | Concen- | in each | of |
| | collected | tration | sample | total |
| Sample | (L) | (g/L) | (grams) | protein |
| Crude extract | | 38.11 | | |
| (undiluted whey) | | | | |
| Dilute Whey | 21 | 2.54 | 52.5 | 100% |
| (1:15 dilution) | | | | |
| Regenerated | 6.5 | 5.00 | 32.5 | 62% |
| Protein | | | | |
| Sample #1 | | | | |
| Regenerated | 6.5 | 5.31 | 34.5 | 65% |
| Protein | | | | |
| Sample #2 | | | | |
| Flow Through | 14.5 | 1.23 | 17.8 | 34% |
| Sample #1 | | | | |

Yield of bound and extracted protein was calculated as a percentage of total protein processed per cycle. An average of 64% of all whey proteins processed using the LINX 140T TDS Cartridge system were bound and extracted during the regeneration phase. Fat content was determined in the regenerated samples from batches 1 and 2, and flow through sample from batch number 1, using the method described in Forcato (2005) J Dairy Sci 88(2):478-481. Lipids present in milk can be determined by UV spectrophotometry based upon the property of fatty acids to absorb UV light proportional to their concentrations. A standard curve of milk fat and UV absorbance at 208 nm was established in order to calculate fat content in each of the samples. 30 μL of each sample was added to 1.5 mL of pure ethanol and chilled at −20° C. for 2 hours to precipitate the protein. The samples were then centrifuged at 13,000 rpm for 15 minutes and the supernatant removed for absorbance measurement at 208 nm. The results are shown in Table 3. The regenerated whey samples contained an average of 120 g/ml fat and the flow through sample contained approximately 375 g/ml. The results are shown in Table 3. About 3 times more fat was recovered in the flow through sample than in the regenerated samples. Since the bound biomolecules in this experiment were eluted during the regeneration phase using dilute whey (identical solution to the feed solution), the presence of fat in the regenerated solution can be accounted for due to carry through. If the bound biomolecules were to be eluted during regeneration phase using an aqueous or buffered solution, the amount of fat in the regenerated solution would be greatly reduced.

TABLE 3

| | | Standard curve | |
|---|---|---|---|
| | | calculation | Average |
| | | (y = A208, | Fat |
| | Average | x = μg/mL | content |
| Sample | A₂₀₈ | Milk fat) | (μg/mL) |
| Crude sample | 0.4309 | y = 0.0004x | 1077.25 |
| (undiluted whey) | | | |
| Regenerated | 0.0509 | y = 0.0004x | 127.25 |
| Sample #1 | | | |
| Recovered | 0.0449 | y = 0.0004x | 112.50 |
| Sample #2 | | | |
| Flow Through | 0.150 | y = 0.0004x | 375.00 |
| Sample #1 | | | |

Lactose content was determined in the regenerated samples from batch numbers 1 and 2, and flow through solution from batch number 1. The presence and characterization of lactose was determined by HPLC-RI method (by ion exclusion HPLC). 500 μL of each sample was filtered through 3K MWCO (Molecular Weight Cut off) centrifugal filter units at 14000 rpm for 10 minutes. Filtered extracts of these samples were analyzed by Ion Exclusion HPLC using an organic acid analysis column. 5 mg/mL lactose was used as a reference standard and duplicate injections of both reference standards and samples were made. Qualitative identification of the lactose in the samples was by comparison of retention times with reference standard and quantitative identification of lactose in samples was by extrapolation with the reference standard area. The regenerated whey samples contained an average of 25% w/w lactose and the flow through sample contained 75% w/w lactose. The results are shown in Table 4. About 4 times more lactose was recovered in the flow through sample than in the regenerated sample. Since the bound biomolecules were eluted the during regeneration phase using dilute whey (identical solution to the feed solution), the presence of lactose in the regenerated stream can be accounted for due to carry through. If the bound biomolecules were to be eluted during regeneration phase using an aqueous or buffered solution, the amount of lactose in the regenerated samples would be greatly reduced.

TABLE 4

| | | | Total | |
|---|---|---|---|---|
| | | | lactose | Approximate |
| | Concen- | Volume | per | percentage of |
| | tration | per sample | sample | total lactose |
| Sample ID | (mg/mL) | (L) | (g) | per cycle |
| Crude sample | 59.78 | | | |
| (undiluted whey) | | | | |
| Diluted whey | 4.76 | 21 | 99.9 | 100% |
| Regenerated Sample #1 | 4.35 | 6.5 | 28 | 25% |
| Regenerated Sample #2 | 4.25 | 6.5 | 27.6 | 25% |
| Flow through Sample #1 | 5.15 | 14.5 | 74.6 | 75% |

### Qualitative Analysis

The samples described in Table 4 were examined by polyacrylamide gel electrophoresis (PAGE) (4-20% acrylamide), with or without prior denaturation of proteins. For reference, one lane included size standards and another lane included 2 mg/ml bovine serum albumin (BSA). For the denaturing gel, fully reducing conditions were employed where samples were pre-treated with β-mercaptoethanol (reduces disulfide bonds) and heat treated to fully denature the proteins prior to loading the gel. For the non-denaturing gel, non-reducing conditions were employed where the samples were not treated with any additional chemicals or heat prior to gel loading to retain proteins in native (non-denatured) configurations. Both sets of samples were run with sodium dodecyl sulfate (SDS) in the buffer (providing uniform negative charge). Proteins were stained with Coomassie Blue for visualization. By visual inspection, the protein banding patterns in both recovered protein and flow through samples were essentially identical in each sample, both under reducing and non-reducing conditions. This indicates that major proteins in whey were recovered in native (e.g., monomeric) form after processing with the LINX® 140T TDS Cartridge system. Since the same proteins were also recovered in the flow through although in lower amounts (concluded by visual inspection of banding patterns on SDS gels) the amount of sample run through the system may have contained more protein than available sites on the ion exchange membranes. This may be alleviated by controlling flow rates and appropriate dilutions of the incoming whey stream.

Example 3

### Procedure

An experiment was performed to determine the reliability and reproducibility of using an electrochemical system with a bipolar water-splitting ion exchange membrane for controlled demineralization of wine. A commercially available LINX® 140T TDS Cartridge system, available from Pionetics Corp., was used. This system includes two cartridges, each with a spiral bound textured bipolar sheet that contains a cation exchange layer abutting an anion exchange layer.

A commercially available cask wine (Franzia-chardonnay) was obtained from Safeway. Samples of wine were passaged through the LINX® 140TTDS Cartridge system with an electric current applied. The conductivity of the wine was approximately 2500 μS/cm the wine was at pH 3.7. The operating parameters were 100-120 Vac, 50/60 Hz, 6 A. The voltage and flow rates were varied; 300V and flow rate <0.5 L/min for “Max voltage” conditions; 65V and flow rate of >0.5 L/min for “Min voltage” conditions. Approximately 5 L of wine was processed through the LINX® 140T TDS Cartridge system under an electric current, separating ions that bound to the membrane from other components in the solutions that did not bind and flowed through the cartridge as a demineralized solution. Bound ions were recovered by regenerating the membrane (by reversing the polarity of the electrodes), with distilled water to produce a “regenerated” solution that contained the ions.

All samples were analyzed for presence and quantity of ions as a measure of conductance measured by a digital conductivity meter (HM Digital COM-100 Waterproof Combo Meter for EC, TDS and Temperature).

Each wine sample was treated in a continuous alternating process between the two cells of the LINX® 140T TDS Cartridge system. Each of the two cells treated the wine simultaneously during the “demineralization phase” after which, water (at pH 8.0) was used as the fluid for the “regeneration” phase. Regeneration began with the first cell providing 2 L of “demineralized” water to the second cell as a solution for its regeneration process (i.e., to release ions bound to the second cell). Next, the second cell provided 2 L of “demineralized water” to the first cell as a solution for its regeneration process (i.e., to release bound ions bound to the first cell). After both cells regenerated, the “cycle” was complete and the system was then ready for the next cycle.

### Quantitative Analysis

Both the regenerated and the flow through samples were collected from each batch and were analyzed quantitatively for the presence of ions as determined by a conductivity measurement. Results are shown in Table 5.

A range between 60 and 90% of the ions, regardless of charge or valence, were removed from each of the wine samples treated respectively, depending on the set voltage applied across the membranes during deionization (Table 5). By varying the voltage across the membrane and controlling the flow rate, the degree of demineralization (amount of ions bound and removed) was able to be controlled. The ions were recovered during the regeneration phase and efficiently removed from the original sample (wine) producing varying degrees of demineralized wine.

### Example 4

An electrochemical system with a bipolar water-splitting ion exchange membrane is used for purification of a specific biomolecule such as a cationic or anionic protein from whey, such as lactoferrin. Lactoferrin is bound to the membrane by using its inherent affinity to bind Fe³⁺ ions. A commercially available LINX® 140T Cartridge system, available from Pionetics Corp., is used. This system includes two cartridges, each with a spiral bound textured bipolar sheet that contains a cation exchange layer abutting an anion exchange layer.

Effective binding and separation of a single protein such as lactoferrin is achieved in a two-step process as described herein. Regardless of the composition of the cation and anion materials used to extrude the bipolar membranes that capable of water-splitting, ions on the membrane (either on the cation or the anion layer or both), such as Fe³⁺ present in an aqueous solution such as, but not limited to Iron (III) sulfate (or ferric sulfate with the formula Fe₂(SO₄)₃), may be replaced during the first few minutes of the “deionization phase”. Since multivalent metals have a very high affinity for the cation and anion exchange layers on the membrane, the surfaces of the membrane will be replaced with Fe³⁺ ions. Once the membranes are “charged with Fe³⁺ ions, demineralized whey (or a derivative of whey such as UFR), can be passaged through the cell as a high flow rate. During this phase, lactoferrin (which is the only whey protein that has an affinity for binding iron) binds to the membrane while the other proteins and biomolecules present in the solution pass through as unbound molecules. Since lactoferrin is present in whey at very low concentrations (<1% of the total proteins), a large volume of whey ((or a derivative of whey such as UFR), can be treated before the system would require regeneration using polarity reversal of the electrodes.

Detection of lactose presence and quantitation in all samples (original feed sample, regenerated sample and the flow through sample) is carried out using commercially available Bovine Lactoferrin Elisa kits. The assay uses affinity purified anti-bovine lactoferrin antibodies for solid phase (micro titer wells) immobilization and horseradish peroxidase (HRP) conjugated anti-bovine lactoferrin antibodies for detection.

Although the foregoing invention has been described in some detail by way of illustration and examples for purposes of clarity of understanding, it will be apparent to those skilled in the art that certain changes and modifications may be practiced without departing from the spirit and scope of the invention, which is delineated in the appended claims. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

1. A method for separation of a biomolecule from a solution, comprising:
applying a voltage to an electrochemical cell that comprises:
(a) a housing comprising an inlet and an outlet;
(b) first and second electrodes:
(c) at least one water-splitting ion exchange membrane between the first and second electrodes, wherein the water-splitting membrane comprises:
(i) a cation exchange layer facing the first electrode and comprising a bound cation; and
(ii) an anion exchange layer facing the second electrode and comprising a bound anion;
(d) a solution that comprises the biomolecule,
wherein the solution flows through a continuous channel from the inlet to the outlet of the cell and contacts the first and second electrodes and the cation and anion exchange layers of the water-splitting membrane,
wherein the biomolecule binds to the cation exchange layer or the anion exchange layer on the water splitting membrane or flows through the electrochemical cell as an unbound molecule.

2.-3. (canceled)

4. A method according to claim 1, wherein the biomolecule is a charged cationic and/or anionic polypeptide, an uncharged polypeptide, a tagged polypeptide, a polynucleotide, a mono-, di-, or oligosaccharide, a sugar alcohol, or a glycol.

5.-15. (canceled)

16. A method according to claim 15, wherein the solution that comprises the biomolecule comprises whey or a derivative of whey selected from a retentate and a permeate of whey ultrafiltration, microfiltration, and/or nanofiltration.

17.-18. (canceled)

19. A method according to claim 2,
wherein the biomolecule is charged in the solution that comprises the biomolecule, and wherein the charged biomolecule replaces either a bound cation on the cation exchange layer or a bound anion on the anion exchange layer of the water-splitting membrane,
said method further comprising reversing the polarity of the first and second electrodes, wherein the bound charged biomolecule is expelled from the membrane, and wherein the charged biomolecule exits through an outlet of the electrochemical cell in a regeneration solution.

20.-33. (canceled)

34. A method according to claim 18, wherein the biomolecule does not foul the membrane as the solution flows through the electrochemical cell and wherein at least a portion of the recovered biomolecule remains in solubilized or precipitated form.

35.-38. (canceled)

39. A method for demineralization of a solution that comprises at least one biomolecule and at least one ion, comprising:
applying a voltage to a first electrochemical cell that comprises:
(a) a first housing comprising an inlet and an outlet;
(b) first and second electrodes:
(c) at least one first water-splitting ion exchange membrane between the first and second electrodes, wherein the water-splitting membrane comprises:
(i) a cation exchange layer facing the first electrode and comprising a bound cation; and
(ii) an anion exchange layer facing the second electrode and comprising a bound anion;
(d) a solution that comprises at least one biomolecule and at least one ion,
wherein the solution flows through a continuous channel from the inlet to the outlet of the cell and contacts the first and second electrodes and the cation and anion exchange layers of the water-splitting membrane,
wherein at least one ion binds to the cation exchange layer or the anion exchange layer on the first water splitting membrane, thereby causing demineralization of the solution by removing or reducing the concentration of at least one ion.

40.-41. (canceled)

42. A method according to claim 39, wherein the concentration, form, and/or biological activity of the biomolecule is substantially unchanged in the solution that exits the electrochemical cell with respect to the solution that entered the cell.

43.-56. (canceled)

57. A method according to claim 39, further comprising reversing the polarity of the first and second electrodes, wherein the bound ion is expelled from the membrane, and wherein the ion exits through an outlet of the electrochemical cell in a regeneration solution.

58. (canceled)

59. A method according to claim 57, wherein the solution that comprises at least one biomolecule and at least one ion is whey or a derivative thereof that comprises cationic and anionic ions, and wherein the cationic and anionic ions are recovered as milk minerals in substantially equivalent ratios and at higher concentrations than in the solution that entered the electrochemical cell.

60.-67. (canceled)

68. A lactose powder, prepared according to the method of claim 39, wherein the solution that comprises at least one biomolecule and at least one ion is a permeate of whey filtration, and wherein the lactose powder is prepared from the solution that flows through the electrochemical cell as a demineralized solution.

69. A milk mineral powder comprising cationic and anionic milk minerals separated from other components in whey according to the method of claim 59.

70. A demineralized powder of whey or a derivative thereof, comprising charged and/or uncharged polypeptides, lactose, and/or fat that have been separated from milk minerals of whey according to the method of claim 39,
wherein the solution that comprises at least one biomolecule and at least one ion comprises whey or a derivative thereof,
wherein the whey or derivative thereof further comprises fat, lactose, and/or charged and/or uncharged polypeptides, wherein substantially all of the fat and lactose and at least a portion of the charged and/or uncharged polypeptides flow through the electrochemical cell as unbound molecules, and
wherein the flow from the electrochemical cell is a demineralized solution comprising substantially all of the fat, lactose, and/or at least a portion of charged and/or uncharged polypeptides of whey.

71.-81. (canceled)

82. A method according to claim 39, wherein the solution that comprises at least one biomolecule and at least one ion comprises a beverage.

83.-87. (canceled)

88. A method according to claim 82, wherein the solution exits the electrochemical cell as a demineralized beverage, wherein the demineralized beverage comprises a reduction in at least one ion comprising chloride, nitrate, phosphate, malate, tartrate, sulfite, sulfate, sodium, potassium, magnesium, calcium, manganese, cadmium, lead, copper, iron and/or mercury.

89. (canceled)

90. A method according to claim 39, wherein the voltage applied to an electrochemical cell controls the degree of demineralization.

91.-99. (canceled)

100. A method according to claim 1, wherein the biomolecule has a binding affinity towards a specific ion, and wherein the biomolecule binds to and exchanges with that specific ion on the cation exchange layer or the anion exchange layer of the water-splitting ion exchange membrane.

101.-115. (canceled)

116. A system for demineralization of a solution that comprises at least one biomolecule and at least one ion, comprising:
(a) a housing comprising an inlet and an outlet;
(b) first and second electrodes;
(c) at least one water-splitting ion-exchange membrane between the first and second electrodes, wherein the water-splitting membrane comprises:
(i) a cation exchange layer facing the first and second electrode and comprising a bound cation; and
(ii) an anion exchange layer facing the second electrode and comprising a bound anion;
(d) a solution that comprises the at least one biomolecule and at least one ion,
wherein the system is configured such that the solution flows through a continuous channel from the inlet to the outlet of the cell and contacts the first and second electrodes and the cation and anion exchange layers of the water-splitting membrane, and
wherein the system is configured such that when a voltage is applied to the electrochemical cell, the at least one ion binds to the cation exchange layer or the anion exchange layer on the water-splitting membrane, thereby causing demineralization of the solution by removing or reducing the concentration of at least one ion, and
wherein the system is configured such that when the polarity of the first and second electrodes is reversed, the at least one bound ion is expelled from the membrane and exits through the outlet of the electrochemical cell in a regeneration solution.

117-137. (canceled)

138. A method according to claim 1, wherein at least one water splitting ion exchange membrane comprises any combination of a strong or weak acid cation membrane layer abutting a strong or weak base anion membrane layer.

139.-144. (canceled)

145. A system according to claim 116, wherein the electrochemical cell comprises two or more water-splitting ion exchange membranes, wherein the water-splitting membranes comprise the same or different ion exchange functional groups and/or the same or different ion exchange capacities.

146. A method according to claim 39, wherein at least one water splitting ion exchange membrane comprises any combination of a strong or weak acid cation membrane layer abutting a strong or weak base anion membrane layer.
